(19) United States
(12) Patent Application Publication
(10) Pub. No.: US 2006/0050016 A1
(43) Pub. Date: Mar. 9, 2006

(54) Image display and method for displaying image

(75) Inventors: Isao Tomisawa, Saitama (JP); Satoshi Sugiura, Saitama (JP)

Correspondence Address: YOUNG & THOMPSON, 745 SOUTH 23RD STREET, 2ND FLOOR, ARLINGTON, VA, 22202, US

(73) Assignee: Pioneer Corporation, Tsurugashima-shi (JP)

(21) Appl. No.: 10/532,057

(22) PCT Filed: Oct. 23, 2003
(86) PCT No.: PCT/JP03/13570

§ 371 Date: Apr. 21, 2005

(30) Foreign Application Priority Data
Oct. 23, 2002 (JP) 2002-307938
Oct. 23, 2002 (JP) 2002-307941

(51) Int. Cl. G09G 3/00

(52) U.S. Cl. 345/32

(57) ABSTRACT

A lens array is arranged in front of the screen of an image display at a distance of S1. The lens array consists of lenses having focal lengths f1 and f2. The focal length f1 and f2 and the distance S1 determine the forming positions of first and second imaging planes. The first imaging plane is formed at a position of distance S3 from the lens array and the second imaging plane is formed at a position of distance S2. More specifically, a pixel on the screen is imaged as a first imaging element of the first imaging plane at a position of S1+S3 form the screen and a pixel on the screen is imaged as a second imaging element of the second imaging plane at a position S1+S2 from the screen. A viewer can attain stereoscopic feeling when viewing them.

### TECHNICAL FIELD

The present invention relates to a technical field of an image display apparatus and an image display method capable of displaying an image including a three-dimension (3D) image.

### BACKGROUND ART

There are proposed various devices such as a CRT (Cathode-Ray Tube), an EL (Electroluminescence), an LC (Liquid Crystal), a PDP (Plasma Display Panel) and so on, as a display apparatus. They are of a type to directly show a user an image, which is displayed on a display apparatus, as a two-dimension (2D) image. On the other hand, various types of a 3D image display apparatus are proposed and in a practical use, which allows showing the user an image as a stereoscopic image by using these devices. Such a 3D image is used for various fields such as an entertainment field, a design field, a medical field and so on. There is a demand for a further effective 3D image display apparatus.

A type of LC (Liquid Crystal) shutter glasses is well known as an example of the 3D image display apparatus. In this type of apparatus, a 3D object is shot from different directions, and then the resulting image data including the parallax information is synthesized into one image signal, and the image signal is inputted into a 2D display apparatus and displayed. The user wears the LC shutter glasses, in which one LC shutter for the right eye is in a light transmissive status and the other LC shutter for the left eye is in a light shield status as for odd field, in while the LC shutter for the left eye is in a light transmissive status and the LC shutter for the right eye is in a light shield status as for even field. In this case, displaying synchronously the right eye image as for odd field and the left eye image as for even field results in that the user can view the right eye image and the left eye image with each eye respectively, each image including the parallax for the right eye or the left eye, so that a stereoscopic image is obtained.

There is also a 3D image display apparatus in which a plurality of display devices are disposed along a view line of the user, so that brightness of object displayed on each display device allows showing user a 3D image.

### DISCLOSURE OF INVENTION

However, the apparatus in this type involving a device which the user wears, or a signal processing for displaying a 3D image. Otherwise, a plurality of display devices are required, or a display device itself involving a complicated structure. Additionally, showing a 3D image depending on the parallax is considered to increase eye fatigue.

Therefore, the present invention has been accomplished in view of the above problems and aims to provide an effective image display apparatus and method having a simple structure, allowing to generate an image displayed on a screen of a 2D display apparatus at a predetermined position, so that the user can view not only a 2D image but also a 3D image.

The present invention will be discussed below.

The image displaying apparatus according to the present invention is provided with: a two dimensional image displaying device; an image providing device including a plurality of lenses disposed in front of and parallel to a display plane of the two dimensional displaying device; an image signal generating device for generating an image signal to be inputted into the two dimensional image displaying device.

According to the image displaying apparatus of the invention, the image providing device disposed in front of the display plane of the two dimensional image displaying device provides (focuses) the image displayed on the display plane at a position different from the display plane. The image provided position (the focus position) is determined by the focus distance of the lens and the distance between the lens and the display plane, so that the image is provided forward or rearward of the display plane. The user feels the displayed image forward or rearward of the display plane by viewing the provided image. The image displaying apparatus preferably has a flat display plane. The provided image may be larger or smaller than the display plane depending on a relationship between the image providing device and the two dimensional image displaying device.

The image displaying apparatus according to the present invention is provided with: a two dimensional image displaying device; an image providing device including a plurality of lenses disposed in front of and parallel to a display plane of the two dimensional displaying device, each lens having any one of a plurality of different focus distances; and an image signal generating device for generating an image signal to be displayed on the two dimensional image displaying device, corresponding to the focus distance of each lens.

According to the image displaying apparatus, the image providing device disposed in front of the display plane of the two dimensional image displaying device provides (focuses) an image at a position different from the image displayed on the display plane. The providing (focusing) position is determined on the basis of the focus distance of each lens and a distance between the lens and the display plane, so that the user feels a 3D image forward or rearward of the display plane. The image signal generating device generates and displays image signals corresponding to each lens. The image displaying apparatus preferably has a flat display plane. The provided image may be larger or smaller than the display plane depending on a relationship between the image providing device and the two dimensional image displaying device. Increasing a quantity of lenses having different focus distances makes it possible to provide much more focusing plane, resulting in showing a further smooth 3D image.

In an aspect of the image display apparatus according to the present invention, the image providing device is configured by a plurality of stocked lens arrays.

According to this aspect, a lens array having different focus distance or a lens array having lenses only for predetermined pixels is used. Using a lens array for which a portion without lens and a portion with lens are arranged in the same size and the same interval, two lens arrays can be stacked in such a manner that a portion with lens in one lens array overlaps with a portion without lens in another lens array, and each portion disposed at a predetermined distance from the display plane, so that two image provided planes (two focusing planes) are obtained. Since the same type of lens array is used, the optical system can be obtained at low cost. Focus distances of individual lenses of two lens arrays to be stacked may be different.

In another aspect of the image display apparatus according to the present invention, the image providing device is set to provide an image of the two dimensional image displaying device at fronts (front portions) of a display plane of the two dimensional image displaying device.

Alternatively, the image providing device is set to provide an image of the two dimensional image displaying device at rears (rear portions) of a display plane of the two dimensional image displaying device.

According to this aspect, the image provided position of the displayed image of the two dimensional image displaying device may be arranged forward or rearward of the display plane, on the basis of a relationship of the focus distance of the lens with a distance between the lens and the display plane. The user can feel a 3D image frontward or rearward of the display plane, by viewing this provided image.

In another aspect of the image displaying apparatus according to the present invention, the lens may be any of an aspheric lens, a Fresnel lens, and a GRIN (grated index) lens.

According to this aspect, a lens form may be selected on the basis of use environment, condition and of on of the apparatus. Furthermore, the lens may be a convex lens, a concave lens or in a flat shaped lens.

In another aspect of the image displaying apparatus according to the present invention, a member having a predetermined refractive index is inserted between the lens and the two dimensional image displaying device.

According to this aspect, inserting a transparent member having high refractive index between the lens and the display plane of the two dimensional image displaying device makes it possible to shorten the optical path, minimize and thin (downsizing) the apparatus.

Incidentally, in order to downsize (minimize and thin) the apparatus, it is preferable to shorten a distance between the lens and the two dimensional image displaying device with the lens itself. If this is difficult, however, this aspect facilitates the downsizing.

In another aspect of the image displaying apparatus according to the present invention, a separating device for optically separating the plurality of lenses is disposed between the plurality of lenses and the two dimensional image displaying device.

According to this aspect, light from the adjacent pixels or from ambient can be prevented, so that quality of the provided image is improved. Incidentally, it is possible to use a lens having no influence of the light from the adjacent pixels or from the ambient. If this is difficult, however, this aspect provides a great advantage.

In another aspect of the image displaying device according to the present invention, the two dimensional image displaying device may be any of a cathode ray tube displaying device, a liquid crystal displaying device, an electroluminescence displaying device, and a plasma displaying device.

According to this aspect, it is preferable for the two dimensional image displaying device that the display plane is flat. The two dimensional image displaying such as the cathode ray tube displaying device, the liquid crystal displaying device, the electroluminescence displaying device, and the plasma displaying device can be selected depending on the use environment, conditions and so on.

In another aspect of the image displaying device according to the present invention, the plurality of lenses are disposed corresponding to each of pixels of the two dimensional image displaying device.

According to this aspect, since the lenses are disposed so that the lenses correspond to each of pixels of the two dimensional image displaying device, the brightness or provided image quality are the same level for all pixels, resulting in the high quality image.

In another aspect of the image displaying apparatus according to the present invention, the plurality of lenses are disposed corresponding to a predetermined block of pixels of the two dimensional image displaying device.

According to this aspect, since one lens corresponds to a plurality of pixels of the two dimensional image displaying device, a construction of the lens array is simplified.

In another aspect of the image displaying apparatus according to the present invention, the plurality of lenses are disposed along a horizontal line of the two dimensional image displaying device.

According to this aspect, since lenses having the same focus distance are aligned along a horizontal line of the two dimensional image displaying device, pixels on the same horizontal line display an image (images) on the same image provided plane. Therefore, generating the image to be inputted into the two dimensional image displaying device is facilitated, because pixels along the same horizontal line display the images on the same image provided plane.

In another aspect of the image displaying apparatus according to the present invention, the plurality of lenses are disposed along a vertical line of the two dimensional image displaying device.

According to this aspect, since lenses having the same focus distance are aligned along a vertical line of the two dimensional image displaying device, pixels along the same vertical line display an image (images) on the same image provided plane. Therefore, generating the image to be inputted into the two dimensional image displaying device is facilitated, because pixels along the same vertical line display images on the same image provided plane.

In another aspect of the image displaying apparatus according to the present invention, the image signal generating device includes at least one of brightness information, color information, size information and focus information, which are added to an image displayed on the display plane.

According to this aspect, a further effective stereoscopic image can be obtained depending on the focused position. That is, depending on the display contents, the brightness, the color, the size, the focus and so on may be changed to provide a synergistic effect exaggerating the depth and 3D effect based on a combination of these factors. For example, the brightness may be increased toward the front, and decreased toward the behind to have a dark shadow, and the size may be increased toward the front and decreased toward the behind. As for color, yellow exaggerates the proximity, while blue exaggerates the deep distance. Furthermore, a good focus (i.e. adjusted focus) exaggerates the proximity, otherwise exaggerates the distance (depth). Thus, one or more information about the brightness, the color, the size, the focus and so on is added to the image displayed on the display plane depending on the image provided position, and outputted after an image conversion according to these informations when displayed. Alternatively, the image converted on the basis of these informations may be stored and then outputted sequentially. Using the aforementioned techniques makes it possible to obtain a further effective stereoscopic image.

The image displaying apparatus is provided with: a two dimensional image displaying device; an image providing device made of a plurality of focus variable lenses in front of and parallel to a display plane of the two dimensional image displaying device; an image signal generating device for generating an image signal to be displayed on the two dimensional image displaying device and information about a focus distance of the focus variable lens; and a focus distance controlling device for controlling the focus distance of the focus variable lens, on the basis of the information about focus distance.

According to the image displaying apparatus of the invention, the image providing device disposed in front of the display plane of the two dimensional image displaying device provides the image displayed on the display plane at a position different from the display plane. The image provided position is determined on the basis of a relationship of the focus distance of the lens of the image providing device with a distance between the lens and the display plane, so that the image is provided forward or rearward of the display plane. The user can feel a 3D image forward or rearward of the display plane by viewing this provided image. The image displaying apparatus has preferably a flat display plane. The provided image is not limited to be displayed at the same magnification, but may be larger or smaller than the display plane, depending on a relationship between the image providing device and the two dimensional image displaying device.

The lens constructing the image providing device is a type of having a variable focus distance to provide the image displayed on the display plane of the two dimensional image displaying device at any position. The image signal generating device generates information about the to-be-displayed image, and distance information for indicating the image provided position of each pixel consisting the image. The focus distance of lens is changed on the basis of the distance information, so that a predetermined pixel image is provided at a desired position. The user can feel an effective stereoscopic image, by viewing the pixel image provided at the desired position.

In an aspect of the image displaying apparatus according to the present invention, the plurality of the focus variable lenses are disposed corresponding to each of pixels of the two dimensional image displaying device.

According to this aspect, since the focus variable lens is disposed corresponding to each of pixels of the two dimensional image displaying device, it is possible to control image provided position for all pixels. Furthermore, it is possible to obtain the provided image evenly in brightness or quality.

In another aspect of the image displaying apparatus according to the present invention, the plurality of the focus variable lenses are disposed corresponding to a predetermined block of pixels of the two dimensional image displaying device.

According to this aspect, since one focus variable lens corresponds to a plurality of pixels of the two dimensional image display device, the construction of the lens array is simplified.

In another aspect of the image displaying apparatus according to the present invention, the focus variable lens is a liquid crystal lens.

According to this aspect, in the focus variable lens, a liquid crystal is filled between two electrodes. The focus distance can be controlled by applying a voltage between these two electrodes. Therefore, applying a voltage corresponding to the distance information between two electrodes makes it possible to control freely the image providing position.

In another aspect of the image displaying apparatus according to the present invention, the liquid crystal lens is a lens system including a fix lens.

In another aspect of the image displaying apparatus according to the present invention, the fix lens is disposed at a liquid crystal side of the liquid crystal lens, or an opposite side to the liquid crystal side, or at said both side.

According to this aspect, the focus variable lens is expected for the improved lens performance, the wider range of lens specification or design, as a complex lens made of a liquid crystal lens and a fix lens. The fix lens may be disposed at a liquid crystal side, or the opposite side thereof, or at both sides. In particular, the fix lens disposed at the liquid crystal side provides an effective control of the focus distance, because molecules of the liquid crystal orient along the curvature of the fix lens.

In another aspect of the image displaying apparatus according to the present invention, the fix lens is any of an aspheric lens, a Fresnel lens, and a GRIN (gradient index) lens. Furthermore, the fix lens may be any of a convex lens and a concave lens.

According to this aspect, the form of the fix lens can be selected on the basis of the use environment, conditions and so on of the apparatus.

In another aspect of the image displaying apparatus according to the present invention, a member having a predetermined refractive index is inserted between the focus variable lens and the two dimensional image displaying device.

According to this aspect, inserting the transparent member having the high refractive index between the focus variable lens and the two dimensional image displaying device makes it possible to shorten the optical path, minimize or thin (downsize) the apparatus.

Incidentally, for the downsizing, it is preferable to shorten the distance between the focus variable lens and the two dimensional image display device with the lens itself. If this is difficult, however, this aspect provides a remarkable effect.

In another aspect of the image displaying apparatus according to the present invention, a separating device for optically separating the plurality of focus variable lenses is disposed between the plurality of focus variable lenses and the two dimensional image displaying device.

According to this aspect, since the light from the adjacent pixels or from the ambient can be prevented, it is possible to improve the provided image. Incidentally, each lens is preferably having no influence of the light from the adjacent pixels or from the ambient. If this is difficult, however, this aspect provides a remarkable effect.

In another aspect of the image displaying apparatus according to the present invention, the two dimensional image displaying device is any of a cathode ray tube displaying device, a liquid crystal displaying device, an electroluminescence displaying device, and a plasma displaying device.

According to this aspect, the two dimensional image displaying device preferably has a flat display plane, and may be selected from a cathode ray tube displaying device, a liquid crystal displaying device, an electroluminescence displaying device, and a plasma displaying device, on the basis of the use environment, conditions of the image displaying apparatus.

In another aspect of the image displaying apparatus according to the present invention, the image signal generating device includes at least one of brightness information, color information, size information and focus information, which are added to an image displayed on the display plane.

According to this aspect, it is possible to obtain a further effective stereoscopic image depending on the image provided position. That is, depending on the display contents, the brightness, the color, the size, the focus and the like may be changed to obtain a synergistic effect exaggerating the depth and the 3D effect due to a combination of these factors. For example, the brightness may be increased toward the front, and decreased toward the behind to have a dark shadow, and the size may be increased toward the front and decreased toward the behind. As for color, yellow exaggerates the proximity, while blue exaggerates the distance (depth). Furthermore, a good focus (i.e. adjusted focus) exaggerates the proximity, otherwise exaggerates the distance (depth). Thus, one or more information about the brightness, the color, the size, the focus and so on is added to the image displayed on the display plane depending on the image provided position, and outputted after an image conversion according to these informations when displayed. Alternatively, the image converted on the basis of these informations may be stored and then outputted sequentially. Using the aforementioned techniques makes it possible to obtain a further effective stereoscopic image.

The image displaying method according to the present invention is provided with: disposing an image providing device made of a plurality of lenses in front of and parallel to a display plane of a two dimensional image displaying device, displaying an image by inputting an image signal generated by an image signal generating device into the two dimensional image displaying device, and providing the displayed image by the image providing device at a position different from the display plane.

According to the image displaying method of the invention, the image displayed on the display plane is provided at a position different from the display plane, i.e. at a position determined by a relationship of the focus distance of the lens with a distance between the lens and the display plane, so that the user can feel the display image forward or rearward of the display plane.

The image displaying method according to the present invention is provided with: disposing an image providing device made of a plurality of lenses, each lens having any one of different focus distances, in front of and parallel to a display plane of a two dimensional image displaying device, displaying an image by inputting an image signal generated by an image signal generating device corresponding to each focus distance of the lenses into the two dimensional image displaying device, and providing the displayed image by the image providing device at a position different from the display plane.

According to the image displaying method of the invention, the image displayed on the display plane is provided at a position different from the display plane, i.e. a position determined on the basis of a relationship of the focus distance of the plurality of the lenses with a distance between these lenses and the display plane, so that the user can feel a 3D image by viewing the focused image.

The image displaying method according to the present invention is provided with: disposing an image providing device made of a plurality of focus variable lenses in front of and parallel to a display plane of a two dimensional image displaying device, displaying an image by inputting an image signal generated by an image signal generating device into the two dimensional image displaying device, and providing the to-be-displayed image at any position by controlling a focus distance of the focus variable lens.

According to this aspect, the image providing device disposed in front of the two dimension image displaying device provides the image, which is displayed on the display plane, at a position different from the display plane. The image provided position is determined by a relationship of the focus distance of the focus variable lens of the image providing device with a distance between the focus variable lens and the display plane, so that the image is provided forward or rearward of the display plane. The user can feel the display image forward or rearward of the display plane, by viewing the provided image. The focus distance of the focus variable lens is included in the image signal to be displayed, as the distance information corresponding to pixels. The focus distance is controlled by the distance information. It is possible to obtain an effective stereoscopic image, since a desired pixel image is provided at a desired position.

### BRIEF DESCRIPTION OF DRAWINGS

FIG. 1 is a view illustrating the first embodiment of the image displaying apparatus according to the present invention.

FIG. 2 is a view illustrating the second embodiment of the image displaying apparatus according to the present invention.

FIG. 3 is a view illustrating the third embodiment of the image displaying apparatus according to the present invention.

FIG. 4 is a view illustrating the image provided position.

FIG. 5 is another view illustrating the image provided position.

FIG. 6 is a view illustrating a way of downsizing the displaying apparatus.

FIG. 7 is a view illustrating the first modified embodiment of the image displaying apparatus according to the present invention.

FIG. 8 is a view illustrating the second modified embodiment of the image displaying apparatus according to the present invention.

FIG. 9 is a view illustrating the third modified embodiment of the image displaying apparatus according to the present invention.

FIG. 10 is a view illustrating a relationship of pixel and lens.

FIG. 11 is a view illustrating another relationship of pixel and lens.

FIG. 12 is a view illustrating the first example of the display mode of the image.

FIG. 13 is a view illustrating the second example of the display mode of the image.

FIG. 14 is a view illustrating the third example of the display mode of the image.

FIG. 15 are views illustrating a modified example of the display mode shown in FIG. 13 or FIG. 14, showing a column like lens array each array disposed along stripes of the display plane.

FIG. 16 is a block diagram illustrating an exemplary specific construction of the image displaying apparatus according to the present invention.

FIG. 17 is a block diagram illustrating another exemplary specific construction of the image displaying apparatus according to the present invention.

FIG. 18 is a view illustrating the fourth embodiment of the image displaying apparatus according to the present invention, during operations.

FIG. 19 is a view illustrating another operational status of the image displaying apparatus shown in FIG. 18.

FIG. 20 is a view illustrating another operational status of the image displaying apparatus shown in FIG. 18.

FIG. 21 are views illustrating a construction of the focus variable lens applied to the image displaying apparatus according to the present invention: (a) is a plan view; (b) is a sectional view along a line A-A of (a); and (c) is a graph showing a relationship between the applied voltage and the refractive index.

FIG. 22 is a view illustrating another construction of the focus variable lens.

FIG. 23 is a view illustrating another construction of the focus variable lens.

FIG. 24 is a view illustrating another construction of the focus variable lens.

FIG. 25 is a view illustrating another construction of the focus variable lens.

FIG. 26 is a view illustrating an exemplary display mode of the image.

FIG. 27 is a view illustrating a specific display mode of the image.

FIG. 28 is a block diagram illustrating a concept of the image displaying apparatus according to the present invention.

FIG. 29 is a block diagram illustrating an exemplary specific construction of the image display apparatus according to the present invention.

### BEST MODE FOR CARRYING OUT THE INVENTION

### First Embodiment

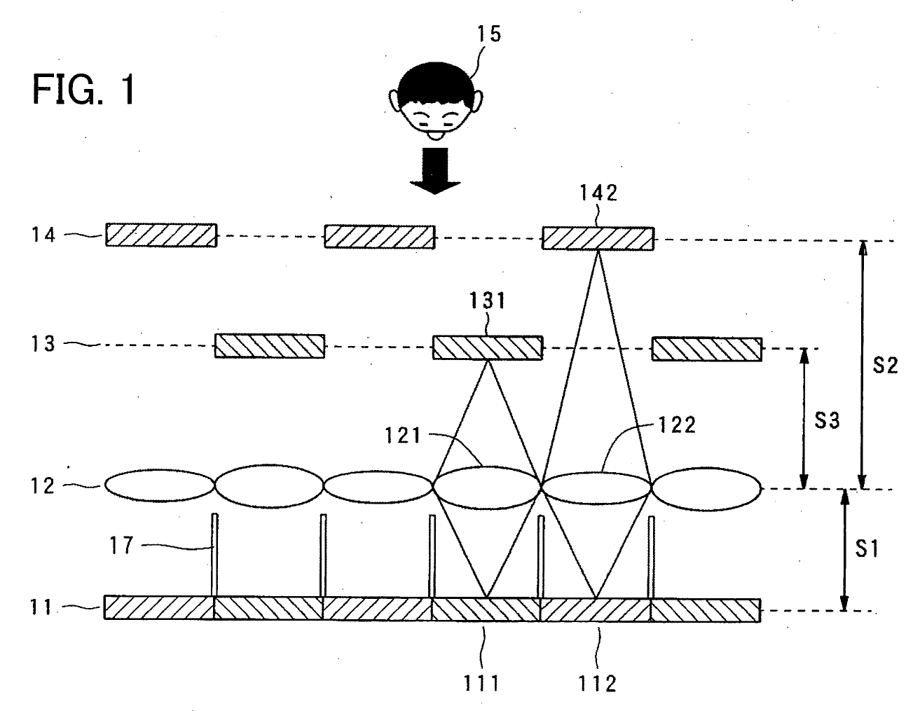

The first embodiment of the image display apparatus according to the present invention will be explained, with reference to FIG. 1. Incidentally, this embodiment relates to a form in which a display image is provided forward of a display plane.

A lens array 12 is positioned forward of the display plane 11 of the image display apparatus with a distance S1. The lens array 12 is made of lenses 121 with a focus distance f1 and lenses 122 with a focus distance f2, which are disposed according to a predetermined rule. The focus distance f1 and the distance S1 determine a distance level of the first image provided plane 13, so that an image is provided apart from the lens array 12 with a distance S3 toward the user 15. On the other hand, the focus distance f2 and the distance S1 determine a distance level of the second image provided plane 14, so that an image is provided apart from the lens array 12 with a distance S2 toward the user 15.

That is, pixels 111 on the display plane 11 provide images as the first imaging pixels 131 on the first image provided plane 13 apart from the display plane 11 with a distance S1+S3, while pixels 112 on the display plane 11 provide images as the second image providing pixels 142 on the second focus plane 14 apart from the display plane 11 with a distance S1+S2. The user 15 feels a stereoscopic effect by viewing the first image providing pixels 131 and the second image providing pixels 142. Incidentally, a light shield device 17 may be disposed between lenses, in order to avoid incidental light from pixels other than a predetermined pixel.

The lens array 12 may be made of lenses with the same focus distance and arrayed on the same plane, in order to provide a plane image forward of the display plane 11.

Furthermore, a plurality of lenses with different focus distances may be arrayed according to a predetermined rule. In this case, a plurality of image provided plane is generated as many as the different focus distance, and thereby a further smooth stereoscopic image can be obtained.

### Second Embodiment

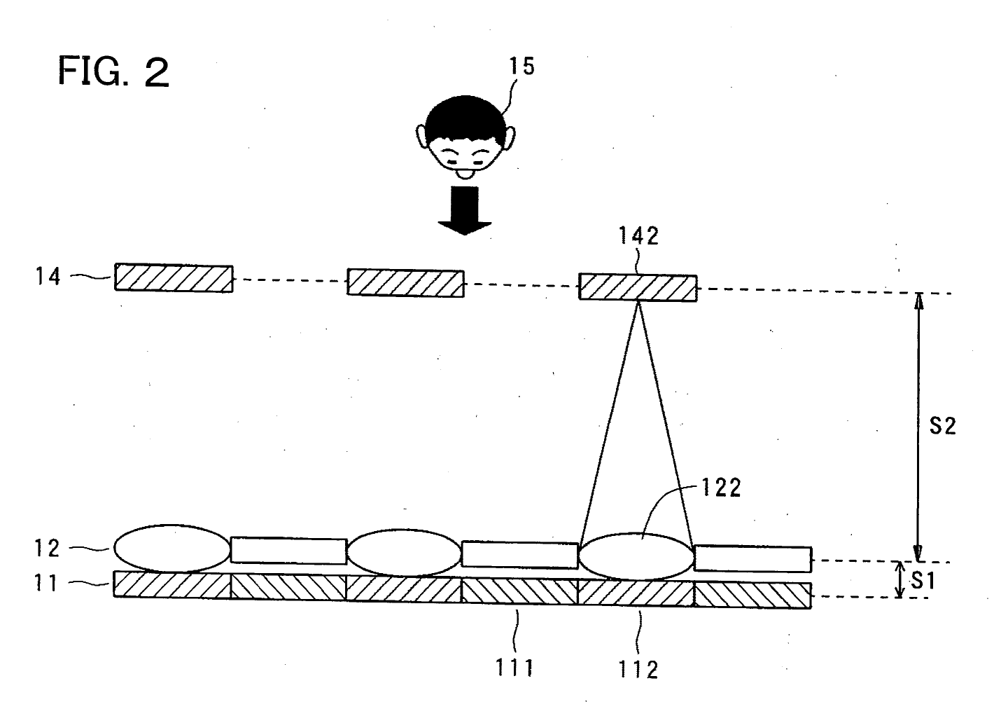

The second embodiment of the image display apparatus according to the present invention will be discussed, with reference to FIG. 2. The lens array 12 is positioned immediately adjacent to the display plane 11 of the image display apparatus. The distance S1 is determined by the thickness of the display plane 11 and the thickness of the lens 12. The lens array 12 is configured by lenses 122 each having the focus distance f2 and no lens portions, which are arrayed according to a predetermined rule. Due to the lenses each having the focus distance f2, the second image provided plane 14 is generated toward the user 15 apart from the lens array 12 with a distance S2. That is, pixels 112 on the display plane 11 provide images as the second image providing pixels 142 on the second image provided plane 14 apart from the display plane 11 with a distance S1+S2. On the other hand, pixels covered with no lens provide images on the display plane 11. Therefore, the user 15 feels the stereoscopic effect by viewing the image displayed on the display plane 11 and the image provided on the second image provided plane 14.

A plurality of lenses with different focus distance may be arrayed according to a predetermined rule. In this case, a further smooth stereoscopic image can be obtained, due to a plurality of images on a plurality of image provided planes as many as the different focus distances and the image displayed on the display plane 11. Incidentally, some values of the focus distance f2 make the image rearward of the display plane 11.

### Third Embodiment

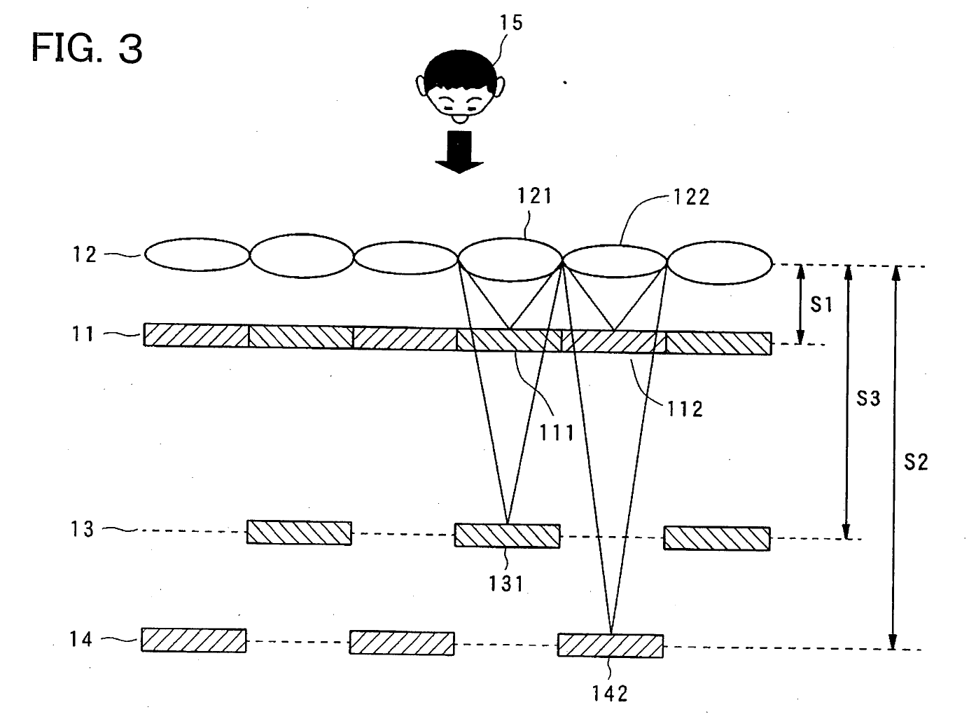

The third embodiment of the image display apparatus according to the present invention will be discussed, with reference to FIG. 3. Incidentally, this embodiment relates to a form in which the display image is provided rearward of the display plane.

The lens array 12 is positioned forward of the display plane 11 of the image display apparatus apart from the display plane 11 with a distance S1. The lens array 12 is configured by lenses 121 each having a focus distance f1 and lenses 122 each having a focus distance f2, which are arrayed according to a predetermined rule. The focus distance f1 and the distance S1 determine a distance level of the first image provided plane 13, so that an image is provided apart from the lens array 12 with a distance S3. On the other hand, the focus distance f2 and the distance S1 determine a distance level of the second image provided plane 14, so that an image is provided apart from the lens array 12 with a distance S2

That is, pixels 111 on the display plane 11 provide images as the first image providing pixels 131 on the first image provided plane 13 apart from the display plane 11 with a distance (S3−S1), while pixels 112 on the display plane 11 provide images as the second pixels 142 on the second image provided plane 14 apart from the display plane 11 with a distance (S2−S1). The user 15 feels a stereoscopic effect by viewing images provided on the first image provided plane 13 and the second image provided plane 14.

The lens array 12 may be made of lenses with the same focus distance and arrayed on the same plane, in order to provide a plane image rearward of the display plane 11.

Alternatively, a plurality of lenses with different focus distance may be arrayed according to a predetermined rule. In this case, a further smooth stereoscopic image can be obtained, due to a plurality of images on a plurality of image provided planes as many as the different focus distances and the image displayed on the display plane 11. Furthermore, similarly to the first embodiment, a light shield device may be disposed between lenses, in order to avoid incidental light from pixels other than a predetermined pixel.

Incidentally, in each embodiment described above, the device to form the display plane 11 may be a display such as a CRT, an LC, an EL, a PDP and so on. Furthermore, the display plane is preferably flat.

Furthermore, the lens may be an aspheric lens, a Fresnel lens, a GRIN (grated index) lens and so on, in addition to the spherical lens. Furthermore, the lens may be a convex lens, a concave lens, or flat shaped lens.

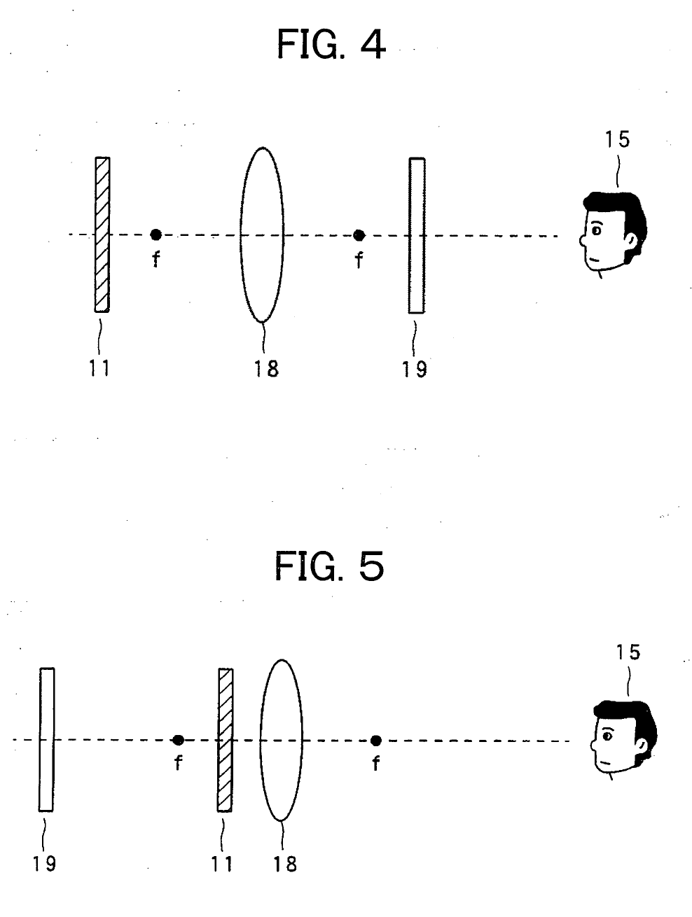

Now, with reference to FIG. 4 and FIG. 5, an explanation is made on a positional relationship between a lens, the focus distance thereof, and the display plane 11, in each case that an image is provided forward or rearward of the display plane 11.

Firstly, in the case that the image is provided forward of the display plane 11 as shown in FIG. 4, the display plane 11 is positioned apart from the lens 18 with a distance equals or more than the focus distance “f” of the lens, opposite to the user 15 with an intervenient of the lens 18. Thereby, an image 19 is provided toward the user 15 via the lens 18. On the other hand, in the case that the image is displayed rearward of the display plane 11 as shown in FIG. 5, the display plane 11 is positioned at a distance within the focus distance “f” from the lens 18, opposite to the user 15 with an intervenient of the lens 18. Thereby, the image 19 is provided as a virtual image opposite to the user 15 via the lens 18. Therefore, the first and second embodiments take a configuration as shown in FIG. 4, while the third embodiment takes a configuration as shown in FIG. 5.

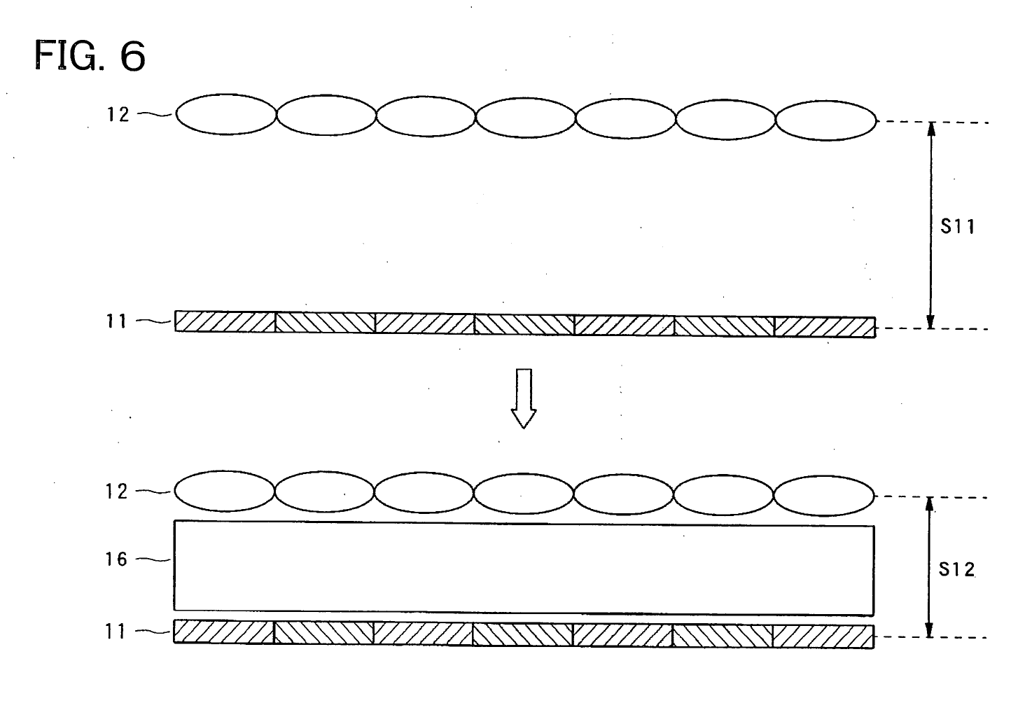

FIG. 6 illustrates a device for further downsizing and thinning the display apparatus with a short length of the optical system. In the upper part of FIG. 6, the display plane 11 and the lens array 12 are positioned with an intervenient distance S11. A device for shortening the distance S11 is illustrated in the lower part of FIG. 6, in which an optically transparent material having a predetermined refractive index is inserted between the display plane 11 and the lens array 12. Therefore, a distance S12 is defined between the display plane 11 and the lens array 12, on the basis of the refractive index of the material, in which distance S12 is shorter than distance S11. It is possible to shorten the distance between the display plane 11 and the lens array 12, and realize the downsized and thinned display apparatus. The intervenient material may be a transparent glass or resin.

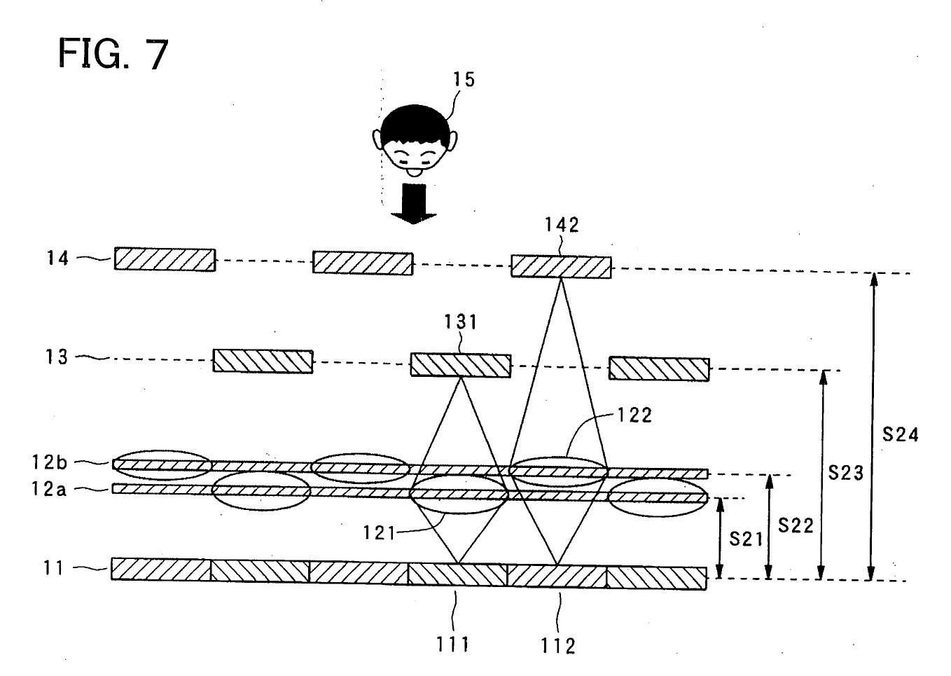

Now, an explanation is made on a modified embodiment of the aforementioned first and third embodiments, with reference to FIG. 7 to FIG. 9.

### First Modified Embodiment

Firstly, as shown in FIG. 7, the first modified embodiment takes a configuration in which two lens arrays 12a, 12b are disposed forward of the display plane 11. The lens arrays 12a, 12b are configured by a plurality of lenses arrayed in a predetermined configuration. The lens array 12a cover pixels that the lens array 12b does not cover and the lens array 12b cover pixels that the lens array 12a does not cover.

The lens array 12a is positioned forward of the display plane 11 of the image display apparatus apart from the display plane 11 with a distance S21. The lens array 12b is positioned forward of the display plane 11 apart from the display plane 11 with a distance S22. In the lens array 12a, lenses 121 each having the focus distance f1 are arrayed corresponding to predetermined pixels 111. On the other hand, in the lens array 12b, lenses each having the focus distance f2 are arrayed corresponding to predetermined pixels 112. The focus distance f1 and the focus distance f2 may be the same.

The lens array 12a provides an image displayed by pixels 111 as the first image providing pixels 131 on the first image provided plane 13 apart from the display plane 11 with a distance S23. The lens array 12b provides an image displayed by pixels 112 as the second image providing pixels 142 on the second image provided plane 14 apart from the display plane 11 with a distance S24. The user 15 feels a stereoscopic effect by viewing the first image providing pixels 131 and the second image providing pixels 142. Levels of the first image provided plane 13 and the second image provided plane 14 may de adjusted by changing the distances S21 of the lens array 12a and distance S22 of the lens array 12b, respectively. Both of the first and second image provided planes 13, 14 may be set rearward of the display plane 11, by shortening the distance between the display plane 11 and the lens array 12a, and the distance between the display plane 11 and the lens array 12b. Furthermore, either one of lens arrays may be disposed at a position between the display plane 11 and the focus position of the lens, so that one image is provided forward of the display plane 11 and the other image is provided rearward of the display plane 11.

The lens arrays 12a, 12b may include lenses with the same focus distance, or may include lenses with different focus distance. A plurality of lens arrays may be used. Thereby, image provided planes are generated as many as the number of lens arrays, so that a further smooth stereoscopic image is obtained.

### Second Modified Embodiment

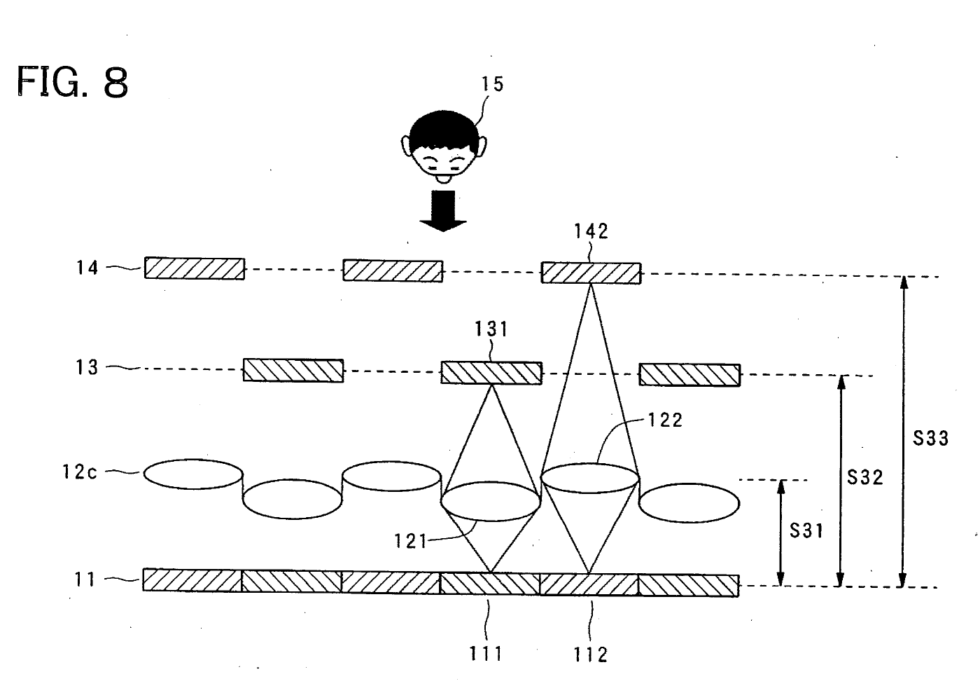

In the second modified embodiment, as shown in FIG. 8, a lens array 12c is positioned forward of the display plane 11 of the image display apparatus with a distance S31. The lens array 12c is configured by a group of lenses each having the focus distance f1 and a group of lenses each having the focus distance f2, which are arrayed in a so-called “zigzag” fashion. Lenses of each group are formed corresponding to pixels 111 and pixels 112, respectively. The focus distance f1 may be the same as the focus distance f2.

Lenses 121 of the lens array 12c provides an image displayed by pixels 111 as the first image providing pixels 131 on the first image displayed plane 13 apart from the display plane 11 with a distance S32. Lenses 122 of the lens array 12c provides an image displayed by pixels 112 as the second image providing pixels 142 on the second image provided plane 14 apart from the display plane 11 with a distance S33. The user 15 feels a stereoscopic effect by viewing the first image providing pixels 131 and the second image providing pixels 142. Levels of the first image provided plane 13 and the second image provided plane 14 can be adjusted by changing the distance S31 of the lens array 12c. Furthermore, the first image provided plane 13 and the second image provided plane 14 can be set rearward of the display plane 11, by controlling the distance between the display plane 11 and the lens array 12c, i.e. by positioning the lens array 12c within the focus distance. Furthermore, lenses of either one lens group may be positioned within the focus distance of the lens, so that one image provided plane is positioned forward of the display plane 11 and the other image provided plane is positioned rearward of the display plane 11.

### Third Embodiment

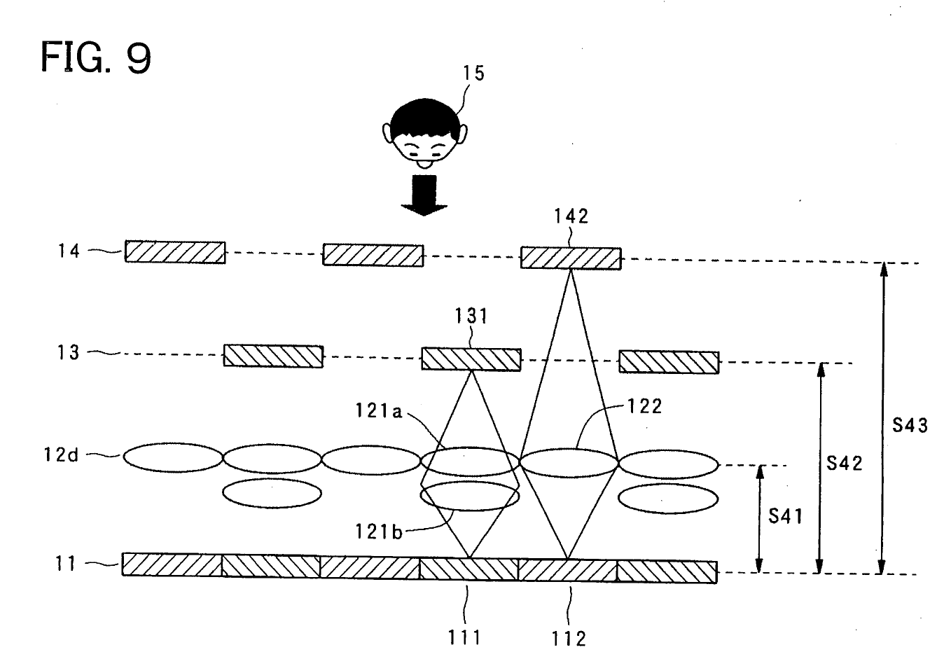

In the third embodiment, as shown in FIG. 9, a lens array 12d is positioned forward of the display plane 11 of the image display apparatus with a distance S41. The lens array 12d is configured by a group of lenses each having the focus distance f1 and a group of lenses each having the focus distance f2, the former group covering all pixels and the latter group covering predetermined pixels.

Compound lenses made of lenses 121a and lenses 121b of the lens array 12d provide an image displayed by pixels 111 as the first image providing pixels 131 on the first image provided plane 13 apart from the display plane with a distance S42. Lenses 122 of the lens array 12d provide an image displayed by pixels 112 as the second image providing pixels 142 on the second image provided plane 14 apart from the display plane 11 with a distance S43. The user 15 feels a stereoscopic effect by viewing the first image providing pixels 131 and the second image providing pixels 142.

Levels of the first image provided plane 13 and the second image provided plane 14 can be adjusted by changing the distance S41 of the lens array 12d. Both or either of the first image provided plane 13 and the second image provided plane 14 may be positioned rearward of the display plane 11, by controlling the distance between the display plane 11 and the lens array 12c.

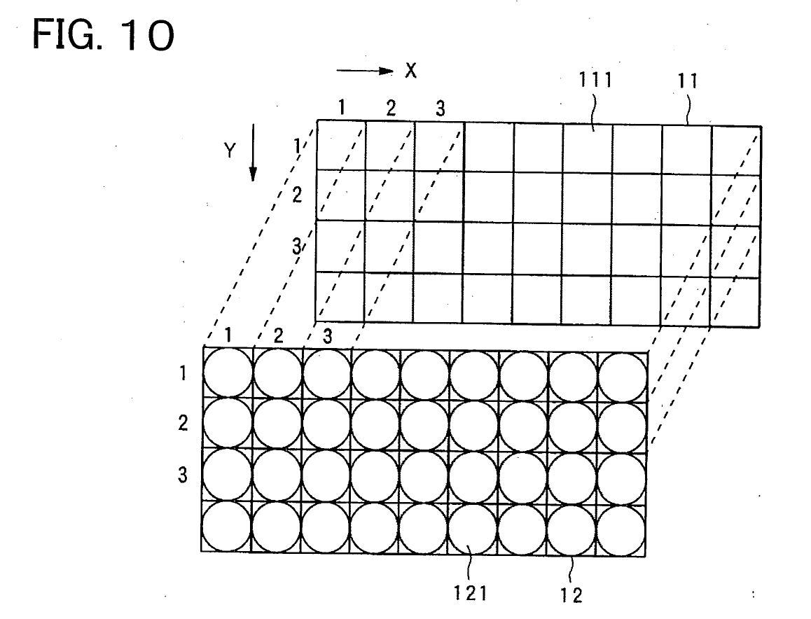

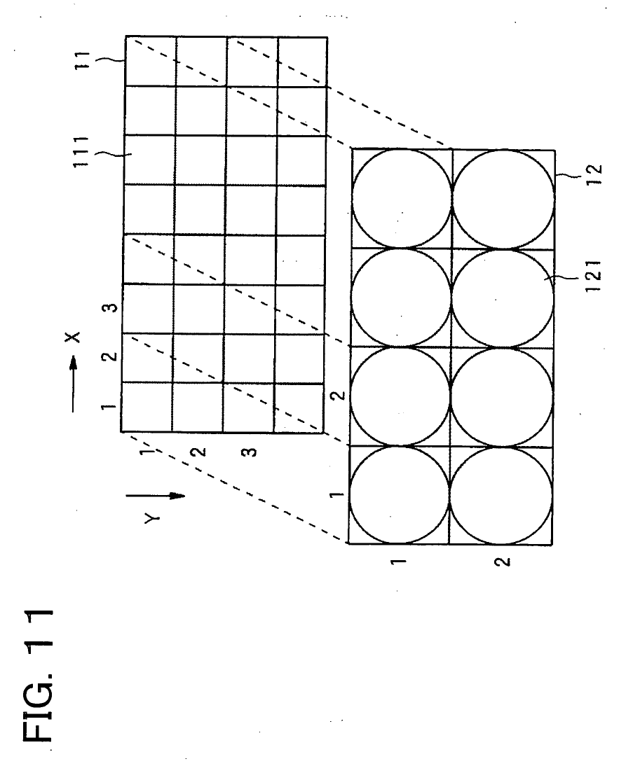

Now, an explanation is made on a relationship between a pixel and a lens, with reference to FIG. 10 and FIG. 11. An example is shown in FIG. 10, in which the display plane 11 is made of pixels 111 arranged in X-Y directions. The lens array 12 is made of lenses 121 each corresponding to each of pixels 111. Each of lenses 121 is in a form to provide an image corresponding to each pixel. Another example is shown in FIG. 11, in which the display plane 11 is made of pixels 111 arranged in X-Y directions. The lens array 12 is made of lenses 121 each corresponding to a set of pixels 111. In FIG. 11, one lens corresponds to four pixels in total, two pixels in X direction and two pixels in Y direction. One lens may correspond to pixels more than four. Each of lenses 121 is in a form to provide an image corresponding to a plurality of pixels.

### FIRST EXAMPLE OF DISPLAY MODE

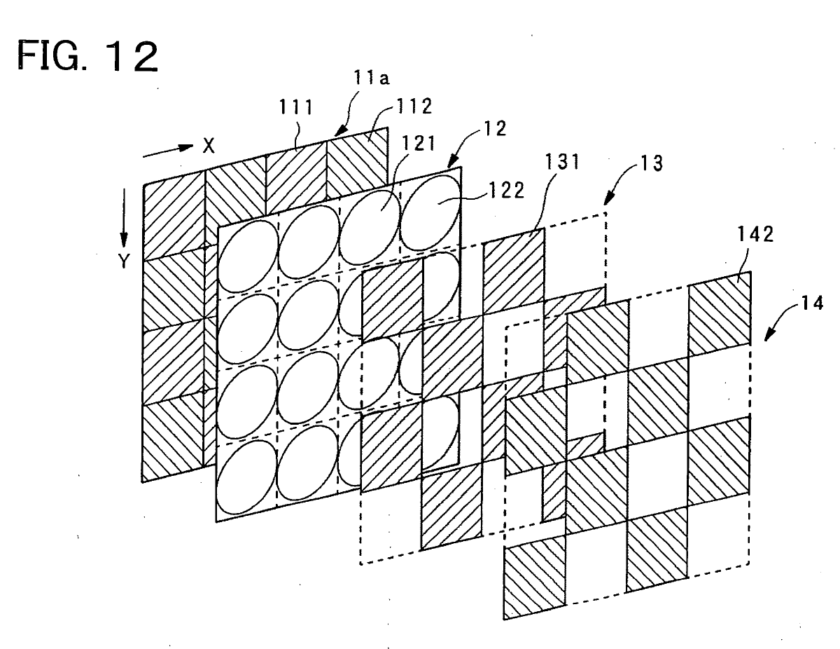

In the first example of the display mode as shown in FIG. 12, a display plane 11a is divided pixel by pixel in X-Y direction. The corresponding image information is supplied to pixels 111 and pixels 112 respectively, where the inputted information is displayed. The lens array 12 is also divided pixel by pixel in X-Y direction. Lenses 121 and lenses 122 are arrayed corresponding to pixels 111 and pixels 112, respectively. The first image provided plane 13 is a plane where pixels 111 are provided (as the first image providing pixels 131) by lenses 121, and the second image provide plane 14 is a plane where pixels 112 are provided (as the second image providing pixels 142) by lenses 122.

Incidentally, lenses 121 and lenses 122 may be arranged so that each lens covers a plurality of pixels, as shown in FIG. 11. In this case, the image information to be imaged on the same image provided plane is displayed on the plurality of pixels covered by each lens 121 or lens 122, of course.

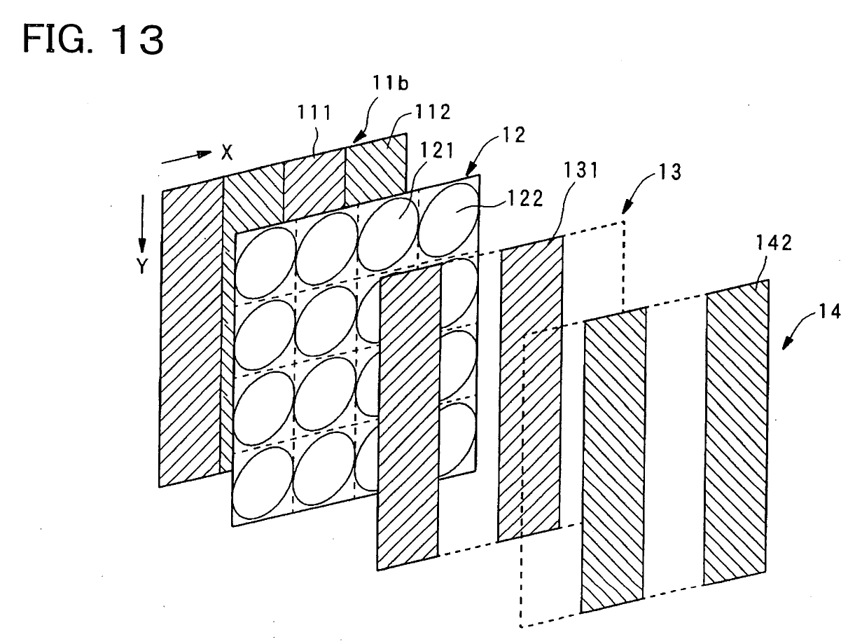

Furthermore, in the second example of the display mode as shown in FIG. 13, a display plane 11b is divided in X direction, to display images corresponding to pixels 111 and pixels 112, respectively. The lens array 12 is also configure by lenses 121 and lenses 122, which are arranged in such a manner that lenses each having the same focus distance are vertically aligned corresponding to pixels 111 and pixels 112, respectively. The first image provided plane 13 is a plane where pixels 111 are provided (as the first image providing pixels 131) by lenses 121 in the vertical line, and the second image provided plane 14 is a plane where pixels 112 is provided (as the second image providing pixels 142) by lenses 122 in the vertical line.

Incidentally, pixels corresponding to lenses 121 and lenses 122 may be aligned horizontally. In this case, the image information to be provided on the same image provided plane is displayed on the plurality of pixels covered by lenses 121 or lenses 122, of course.

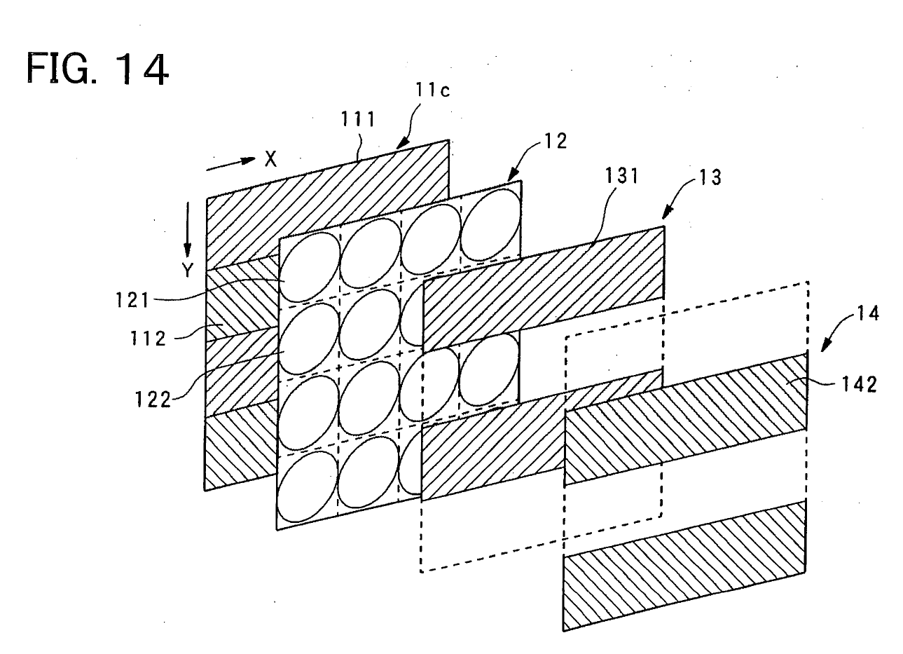

Furthermore, in the third example of the display mode as shown in FIG. 14, a display plane 11c is divided in Y direction, so that images corresponding to pixels 111 and pixels 112 respectively are displayed. The lens array 12 is also made of lenses 121 and lenses 122 arrange so that lenses each having the same focus distance are aligned horizontally. The first image provided plane 13 is a plane where pixels 111 are provided by lenses 121 as horizontal lines (the first image providing pixels 131), and the second image provided plane 14 is a plane where pixels 112 are provided by lenses 122 as horizontal lines (the first image providing pixels 142).

Incidentally, pixels corresponding to lenses 121 and lenses 122 respectively may be aligned vertically. In this case, the image information to be provided on the same image provided plane is displayed on the plurality of pixels covered by lenses 121 or lenses 122, of course.

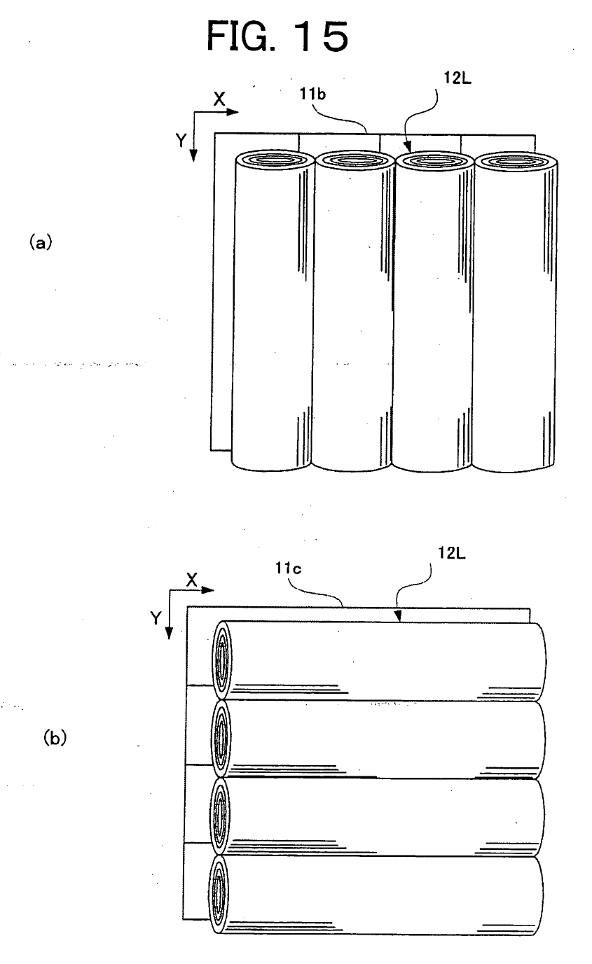

Incidentally, as shown in FIG. 15(a), in the example of the display mode shown in FIG. 13, a column type lens array 12L may be used, which may includes rod lenses or lenticular lenses (i.e. so-called “hog-backed” shaped lenses) arranged on the display plane 11b along strips extending vertically (Y direction). The focus distance of each rod lens or each lenticular lens forming the column type lens array 12L is set to be the same corresponding to the same image provided plane, to provide images on the first image provided plane 13 and the second image provided plane 14 shown in FIG. 13. That is, as show in FIG. 13, two focus distances corresponding to two image provided planes are alternately arranged column by column. Such a lens can be manufactured easily, which is very advantageous to construct a low cost system.

Similarly, as shown in FIG. 15(b), in the example of the display mode shown in FIG. 14, a column type lens array 12L may be used, which may includes rod lenses or lenticular lenses arranged on the display plane 11c along strips extending horizontally (X direction). The focus distance of each rod lens or each lenticular lens forming the column type lens array 12L is set to be the same corresponding to the same focus plane, to provide images on the first image provided plane 13 and the second image provided plane 14 shown in FIG. 14. That is, as show in FIG. 14, two focus distances corresponding to two image provided planes are alternately arranged row by row.

### First Specific Embodiment of Image Display Apparatus

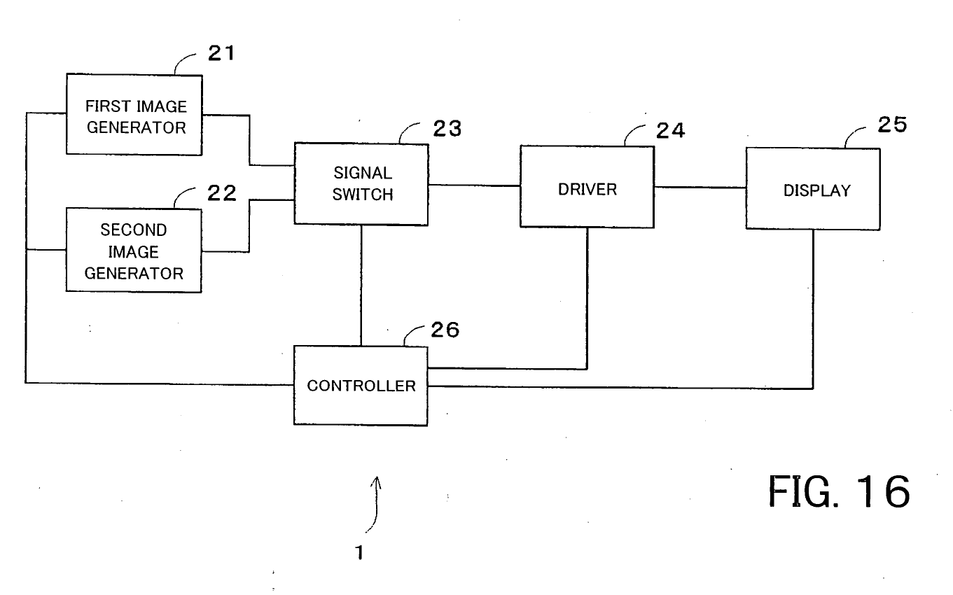

The first specific embodiment of the image display apparatus according to the present invention will be explained, with reference to FIG. 16. The image display apparatus 1 in this specific embodiment is provided with: a first image generator 21 and a second image generator 22 for generating a to-be-displayed image; a signal switcher 23 for switching image signals from the first image generator 21 and the second image generator 22; a driver 24 for driving the display apparatus on the basis of the switched signal; a display 25 for displaying a stereoscopic image; and a controller for controlling an entire operation of the apparatus.

The first and second image generators 21, 22 are signal sources to supply images to be provided on the first image provided plane 13 and the second image provided plane 14 respectively, including various kinds of signal such as a broadcasting image, a reproduction image of a VCR, a graphic image of a computer and so on.

The signal switcher 23 switches signals from the first and second image generators 21, 22 to select the to-be-displayed image. If the display 25 is configured as shown in FIG. 12, the switching is performed pixel by pixel. Otherwise configured as shown in FIG. 13, the switching is performed so that signals from the same image generator are displayed for each vertical line. Otherwise configured as shown in FIG. 14, the switching is performed so that signals from the same image generator are displayed for each horizontal line. If lenses further correspond to a plurality of pixels, the switching is performed so that signal from the same image generator is displayed on these pixels.

The driver 24 is for inputting the signal selected at the signal switcher 23 into the display apparatus, to display the image on the display 25.

The display 25 is for displaying the selected image, by which the user 15 views a stereoscopic image. The display apparatus may be a CRT, an LC, an EL, a PDP and so on, and the display 25 is preferably flat.

The controller 26 is for controlling the operation of the image display apparatus 1. It may include a CPU, and adjusts a synchronous timing of the first image generator 21 and the second image generator 22, and instructs the switching operation of the signal switcher 23 on the basis of the synchronous timing.

### Second Specific Embodiment of Image Display Apparatus

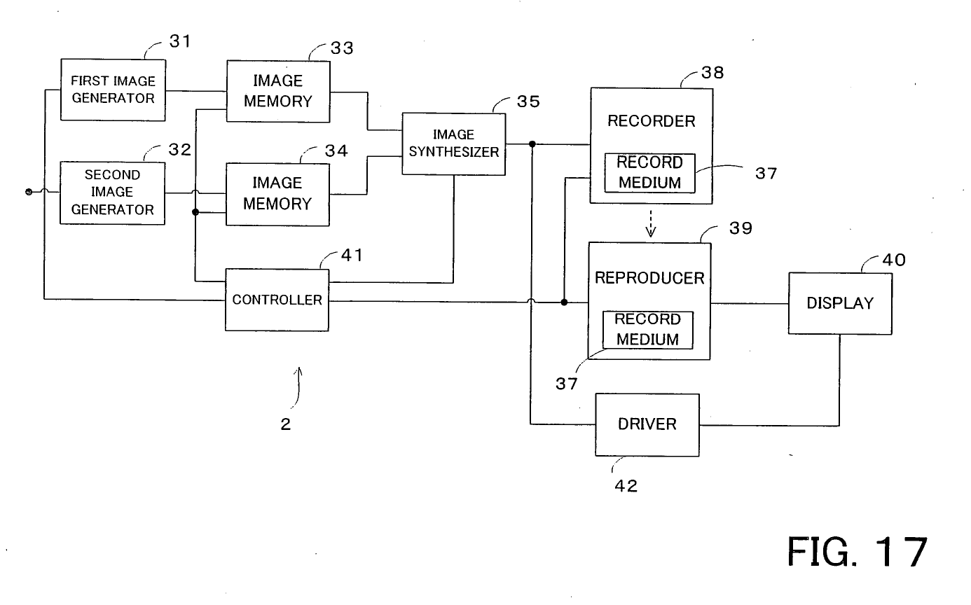

The second specific embodiment of the image display apparatus according to the present invention will be explained, with reference to FIG. 17. The image display apparatus 2 in this specific embodiment is provided with: a first image generator 31 and a second image generator 32 for generating a to-be-displayed image; an image memory 33 for storing an image from the first image generator 31; an image memory 34 for storing an image from the second image generator 32; an image synthesizer 35 for synthesizing image information stored in the image memories 33, 34; a recorder for recording the image information synthesized at the image synthesizer 35 into a record medium 37; a reproducer for reproducing the record medium 37; a display 40 for displaying a stereoscopic image; and a controller 41 for controlling an entire operation of the apparatus.

The first and second image generator 21, 22 are signal sources to supply images to be provided on the first image provided plane 13 and the second image provided plane 14 respectively, including various kinds of signal such as a broadcasting image, a reproduction image of a VCR, a graphic image of a computer and so on.

The image memories 33, 34 temporarily store signals from the first and second image generators 21, 22, respectively. Image to be stored is at least a field image, preferable a frame image.

The image synthesizer 35 synthesizes a to-be-displayed image from the image information stored in the image memories 33, 34. For example, the display mode is as shown in FIG. 12, the image is formed pixel by pixel. If it is as shown in FIG. 13 or FIG. 14, the same image is aligned horizontally or vertically.

The recorder 38 is for recording the image information synthesized at the image synthesizer 35 into the record medium 37. The record medium 37 may be a magneto-optical record medium, an optical record medium, a semiconductor record medium and so on.

The reproducer 39 reproduces the image information recorded in the record medium 37, and inputs it into the display apparatus to display it on the display 40. Using the record medium 37 like this makes it possible to stock 3D image software and distribute it widely.

The display 40 is for displaying the image reproduced from the record medium 37, by which the user 15 views a 3D image. The display apparatus may be a CRT, an LC, an EL, a PDP and so on, and the display 25 is preferably flat.

The controller 41 controls the operation of the image display apparatus 2. For example, it includes a CPU, instructs the image sampling timing from the first and second image generators 21, 22, and controls operations of the recorder 38 and the reproducer 39.

Incidentally, the image information synthesized at the image synthesizer 35 may be inputted directly into the driver 42 and displayed on the display 40.

According to the image display apparatuses 1, 2 mentioned above, signals from two different kinds of signal source are provided respectively on two different image provided planes, so that the user views 3D images. Alternatively, two kinds of signal may be provided on the same image provided plane, so that the user views a 2D image on a plane other than the display plane.

Incidentally, the image display apparatuses 1, 2 mentioned above provide two image provided planes respectively. Nevertheless, it is possible to achieve an image display having three or more image provided planes with three or more signal systems.

### Fourth Embodiment

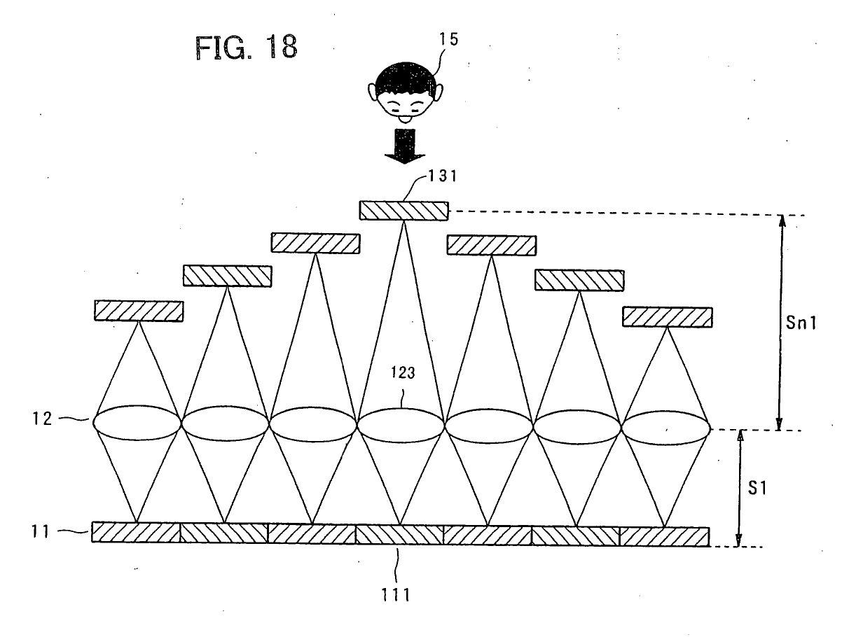

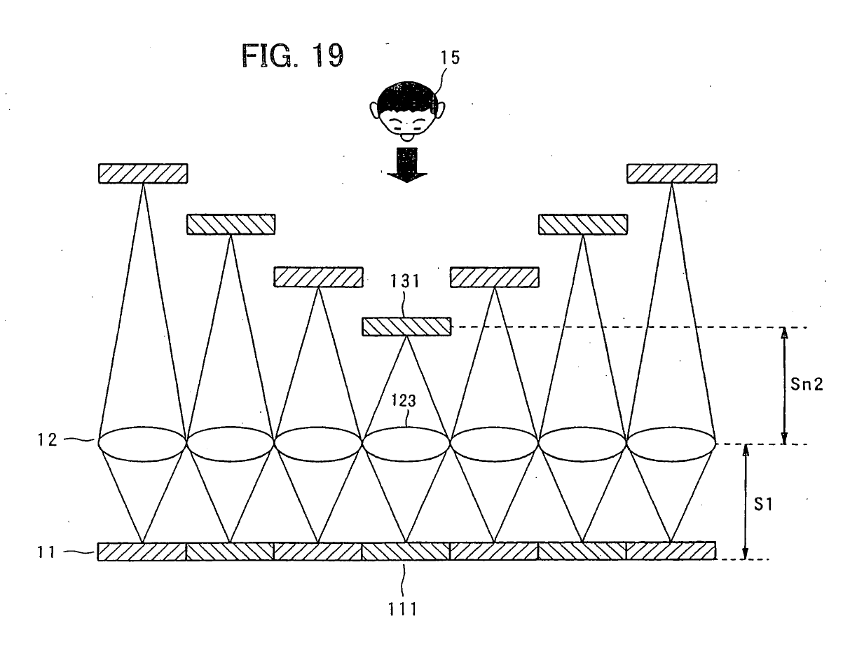

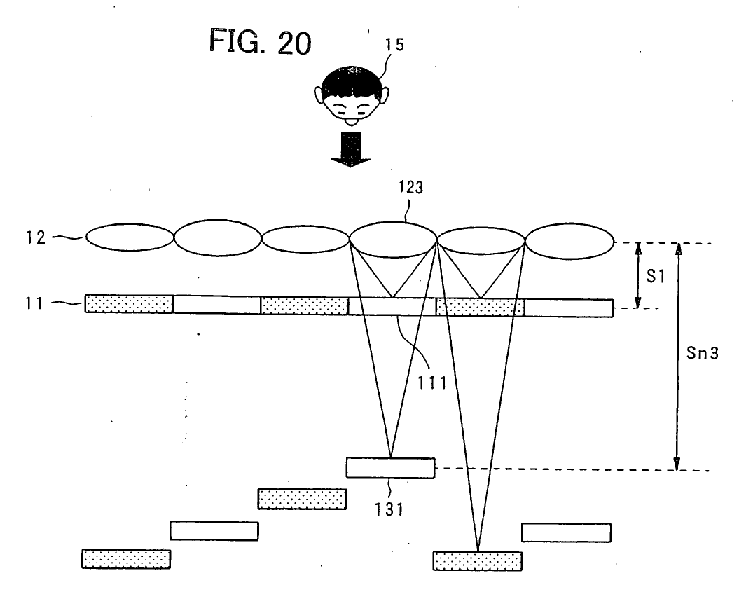

Now, an embodiment of the image display apparatus according to the present invention will be explained, with reference to FIG. 18 to FIG. 20. FIG. 18 and FIG. 19 relate to operational manners in which a display image is provided forward of the display plane of the 2D display device, and FIG. 20 relates to an operational manner in which a display image is provided rearward of the display plane.

As shown in FIG. 18, the image display apparatus according to the present invention is provided with a display plane 11 and a lens array 12 disposed apart from the display plane 11 with a distance S1, and made of focus-variable lenses 123, and further provided with a device for changing a focus distance of the lens 123. Focus-variable lenses 123 may be LC lenses. In this case, the focus distance is controlled by applying a voltage to two electrodes sandwiching an LC. Furthermore, information for controlling the focus distance is supplied with the image signal to be displayed. The information for controlling the focus distance may correspond to a distance of object, and may be supplied for every pixels to be displayed, or may be supplied for allover pixels.

Now, a display mode of the image display apparatus will be explained. The lens array 12 is positioned forward of the display plane 11 of the apparatus, apart from the display plane with a distance S1. The lens array 12 is configured by lenses 123 each capable of changing the focus distance, arrayed according to a predetermined rule. On the basis of the focus distance f of the lenses 121 and the distance S1 between lenses 123 and the display plane 11, an image displayed on the display plane 11 (e.g. pixels 111) may be provided as real image providing pixels (i.e. the first image providing pixels) apart from the lens array 12 with a distance Sn1. That is, the image of pixels 111 each corresponding to lenses 123 is provided at a level determined on the basis of the focus distance f of each of lenses 123. Each of lenses 123 can change the focus distance f independently of each other, for example, by means of an electronic device. Thereby, imaging levels of pixels 111 may be determined independently of each other.

Therefore, as for an entire image displayed on the display plane 11, the entire image may be provided in such a manner that objects existing forward is projected toward the user, while objects existing rearward is retrieved and thereby the user views a real stereoscopic image. In FIG. 18, focus distances of lenses 123 are controlled so as to become longer gradually toward the center, resulting in an example of the center projected imaging.

In FIG. 19, focus distances of lenses 123 are changed to form a display mode in which the center portion provides at a position near the display plane 11, and focus distances f of lenses 123 are controlled so as to become shorter gradually to the center.

FIG. 18 and FIG. 19 illustrates a case that a distance between a lens 123 and the display plane 11 is longer than a focus distance of the lens 123, and thereby images are provided forward of the display plane 11, toward the user 15.

FIG. 20 illustrates a case that a distance between a lens 123 and the display plane 11 is shorter than a focus distance of the lens 123, and thereby images are provided rearward of the display plane 11, opposite to the user 15 with the intervenient of the display plane 11. The distance S1 between the lens 123 and the display plane 11 is shorter than the focus distance f of the lens 123, and thereby an image of a pixel 111 is provided as a virtual image providing pixel 131 apart from the lens 123 with a distance Sn3, rearward f the display plane 11.

Incidentally, focus distances f of all lenses 123 may be controlled so as to be the same, so that a 2D planar image is obtained forward or rearward of the display plane 11.

A lens capable of changing the focus distance, i.e. a focus variable lens may be used as a complex lens in which a fix lens having a fixed focus distance is coupled to an LC lens made of an LC. The fix lens may be an aspheric lens, a Fresnel lens, a gradient index lens and so on.

Furthermore, the focus variable lens may be a convex lens, a concave lens, or flat shaped lens.

Furthermore, one lens 123 may be adapted to cover a plurality of pixels as one pixel group.

Furthermore, a light shield device may be disposed between lenses, in order to avoid incidental light from pixels other than a predetermined pixel into the lens.

Incidentally, in embodiments mentioned above, the device to form the display plane 11 may be a CRT, an LC, an EL, a PDP and so on, and the display plane is preferably flat.

Owing to positioning the lens array 12 in association with the display plane 11, the image to be provided is not necessarily the same size as the display plane, but may be larger or smaller than the display plane 11.

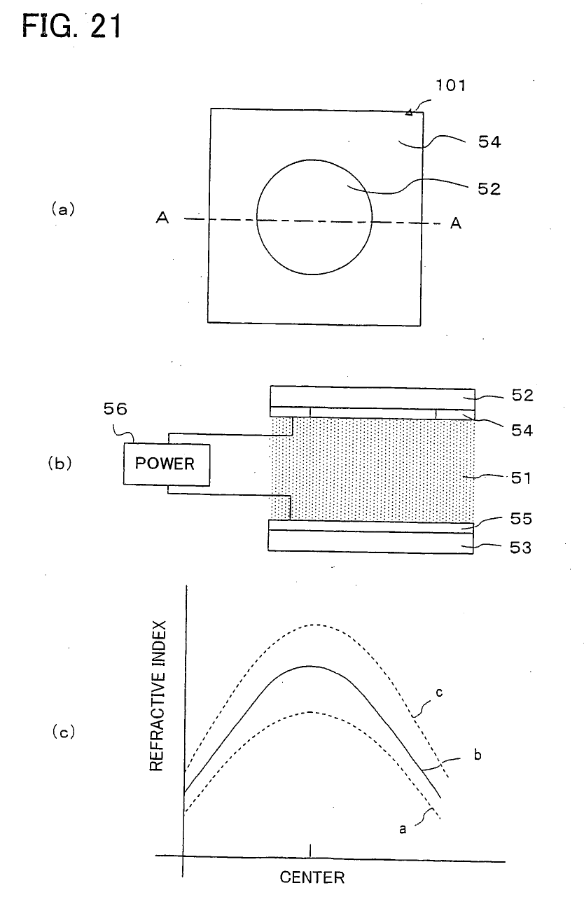

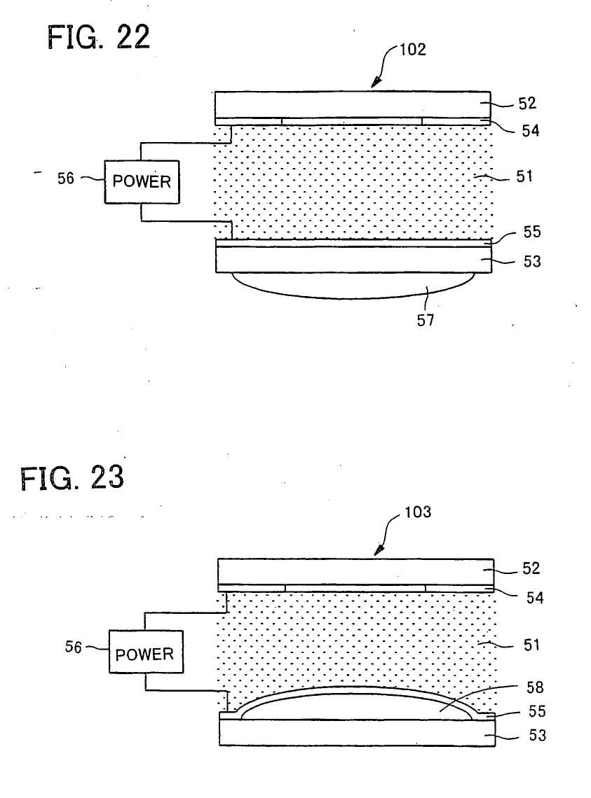

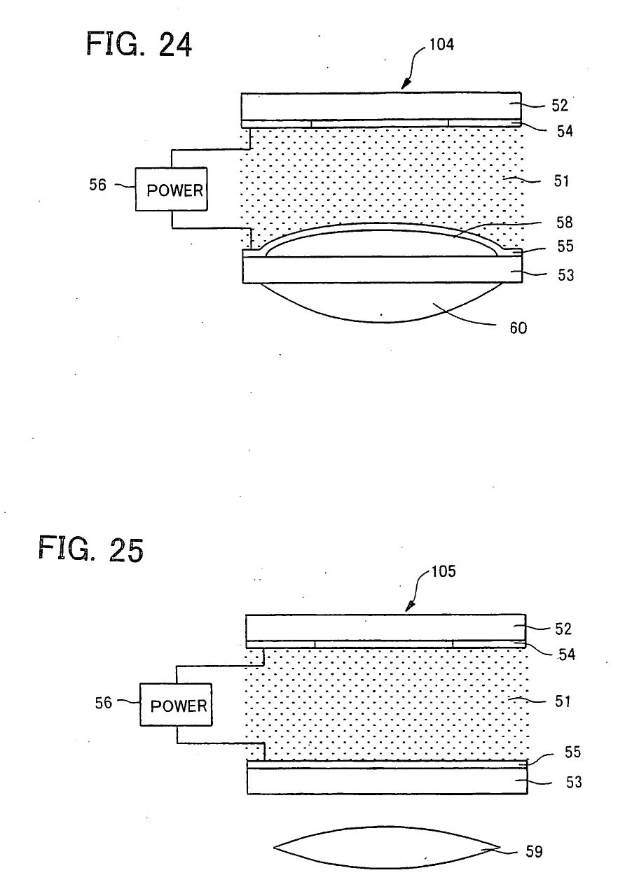

Now, an LC lens as the focus variable lens will be explained, with reference to FIG. 21 to FIG. 25. FIG. 21 shows the first example, FIG. 22 shows the second example, FIG. 23 shows the third example, FIG. 24 shows the fourth example and FIG. 25 shows the fifth example.

FIG. 21(a) shows a plane of an LC lens 1 as the first example, FIG. 21(b) shows a section along a line A-A of FIG. 21(a), FIG. 21(c) shows refraction index distribution of an LC lens 101. The LC lens 1 is constructed in such a manner that, as shown in FIG. 21(b), an LC 51 is encapsulated between two transparent substrates 52, 53. Furthermore, a transparent electrode 54 formed as shown FIG. 21(a) with the center part being removed off in a form of circle is formed on the transparent substrate 52 at a side, which contacts with the LC 51, and a transparent electrode 55 is formed on the transparent substrate 53 at a side, which contacts with the LC51.

An electric power source 56 applies a voltage between the transparent electrodes 54, 55, so that the refraction distribution of the LC 51 is changed and thereby a focus variable lens is formed. The refractive index distribution changes depending on the applied voltage, as shown in FIG. 21(c), which provides a lens function. Curves a, b and c are representative of refractive index distributions determined depending on the applied voltage, in which the refractive index is maximum at the center part of curves. Furthermore, higher the applied voltage is, larger the change in the distribution curve is. Therefore, the focus distance can be controlled by the applied voltage, in which a provided position is controlled by applying a voltage corresponding to distance information.

FIG. 22 shows a sectional view of an LC 102, in which the LC 51 is encapsulated between transparent substrates 52, 53. Transparent electrode 54 is formed on the transparent substrate 52 at a side, which contacts with the LC 51 and transparent electrode 55 is formed on the transparent substrate 53 at a side, which contacts with the LC 51. A fix lens 57 is disposed on the transparent substrate at an opposite side of the LC 51. The electric power source 26 applies a voltage between transparent electrodes 54, 55, so that the refractive index distribution of the LC is changed, and thereby a focus variable lens is formed. Therefore, the focus distance can be controlled by the applied voltage, in which a provided position is controlled by applying a voltage corresponding to distance information.

FIG. 23 shows a sectional view of an LC 103, in which the LC 51 is encapsulated between transparent substrates 52, 53. Transparent electrode 54 is formed on the transparent substrate 52 at a side, which contacts with the LC 51, and transparent electrode 55 is formed on the transparent substrate 53 at a side, which contacts with the LC 51. A fix lens 58 is disposed on the transparent substrate 53 at a side of the LC 51. An electric power source 56 applies a voltage between transparent electrodes 54, 55, so that the refractive index distribution of the LC 51 is changed and thereby a focus variable lens is formed. Therefore, the focus distance can be controlled by the applied voltage, in which a provided position is controlled by applying a voltage corresponding to distance information. Incidentally, since the LC lens 103 has the fix lens 58 disposed to contact with the LC 51, molecules of the LC 51 are oriented along a curved plane of the fix lens 58, when the voltage is applied, which leads a more effective change in the refractive index distribution.

FIG. 24 shows a sectional view of an LC lens 104, in which the LC 51 is encapsulated between transparent substrates 52, 53. Transparent electrode 54 is formed on the transparent substrate 52 at a side, which contacts with the LC 51, and transparent electrode 55 is formed on the transparent substrate 53 at a side, which contacts with the LC 51. Fix lenses 58, 60 are disposed both side of the transparent substrate 53, respectively. The electric power source 56 applies a voltage between transparent electrodes 54, 55, so that the refractive index distribution is changed, and thereby a focus variable lens is formed. Therefore, the focus distance is controlled by the applied voltage, in which a provided position is controlled by applying a voltage corresponding to distance information.

FIG. 25 shows a sectional view of an LC lens 105, which is a focus variable lens with a fix lens 59 disposed outside of the LC lens 101 shown in FIG. 21. The electric power source 56 applies a voltage between transparent electrodes 54, 55, so that the refractive index distribution is changed, and the focus distance is determined on the basis of this change in the refractive index distribution and the fix lens 59. Therefore, the focus distance can be controlled by the applied voltage, in which a provided position is controlled by applying a voltage corresponding to distance information.

Incidentally, in LC lenses 101 to 105 mentioned above, a shape of the transparent electrode 54 is not limited to the circle shape as shown in FIG. 21(a). Furthermore, the circle shape is not always applied to the transparent electrode 54, but may be applied to the transparent electrode 55, or both transparent electrode 54, 55. Any optimum shape may be taken depending on specifications, conditions, LC types and so on. For example, a transparent electrode may be disposed on the transparent substrate as a side, which does not contact with the LC, or may be disposed on planes of fix lenses 57, 58. Furthermore, fix lenses 57, 58, 59, 60 are not limited to convex lenses, but may be concave lenses.

### EXAMPLE OF 3D IMAGE DISPLAY

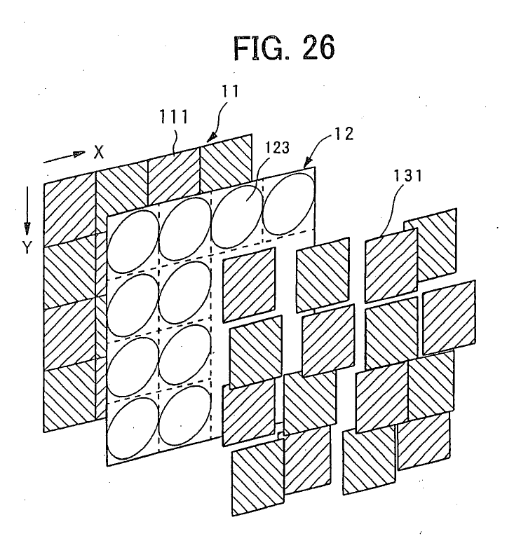

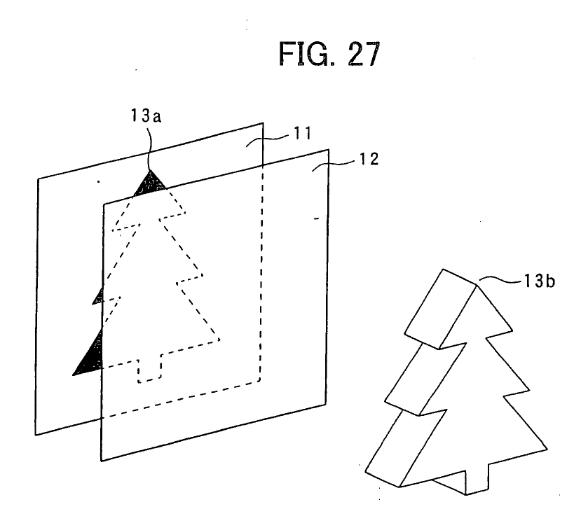

Now, an example of 3D image display in the fourth embodiment will be explained, with reference to FIG. 26 and FIG. 27. As shown in FIG. 26, image information is displayed on the display plane 11, the image information is inputted pixel by pixel in X-Y directions, respectively. The lens array 12 is also configured by focus variable lenses 123 disposed pixel by pixel in X-Y directions, corresponding to each pixel 111. With regard to each pixel 111, an imaging pixel 131 is formed at a level defined by the focus distance of the corresponding lens 123 and a distance between the display plane 11 and the lens array 12. Therefore, an image can be obtained for which a provided position of the to-be-displayed object and the portion thereof are controlled independently of each other.

FIG. 27 shows a specific example, in which an image 13a is displayed on the display plane 11, and a provided image 13b is formed by the lens array 12. For example, if the provided image 13b is a tree, a provided image of a branch extending forward is formed by changing a focus distance of the lens 123 corresponding to the pixel 111 displaying the branch and thereby providing the image providing pixel 131 nearer to the user 15. On the other hand, a provided image of a branch extending rearward is formed by changing the focus distance of the lens 123 corresponding to the pixel 111 displaying the branch and thereby providing the image providing pixel 131 further from the user 15. Viewing the provided image formed as such gives a natural stereoscopic effect to the user 15.

Furthermore, in order to improve the visual effect, brightness information, color information, size information and focus sense information corresponding to the provided position of the pixel 111 may be added to the to-be-displayed image signal. For example, reducing the brightness of an object existing far away improves the perspective strengthening the distance of the object, while increasing the brightness of an object existing closer improves the perspective strengthening the proximity of the object.

### THIRD SPECIFIC EXAMPLE OF IMAGE DISPLAY APPARATUS

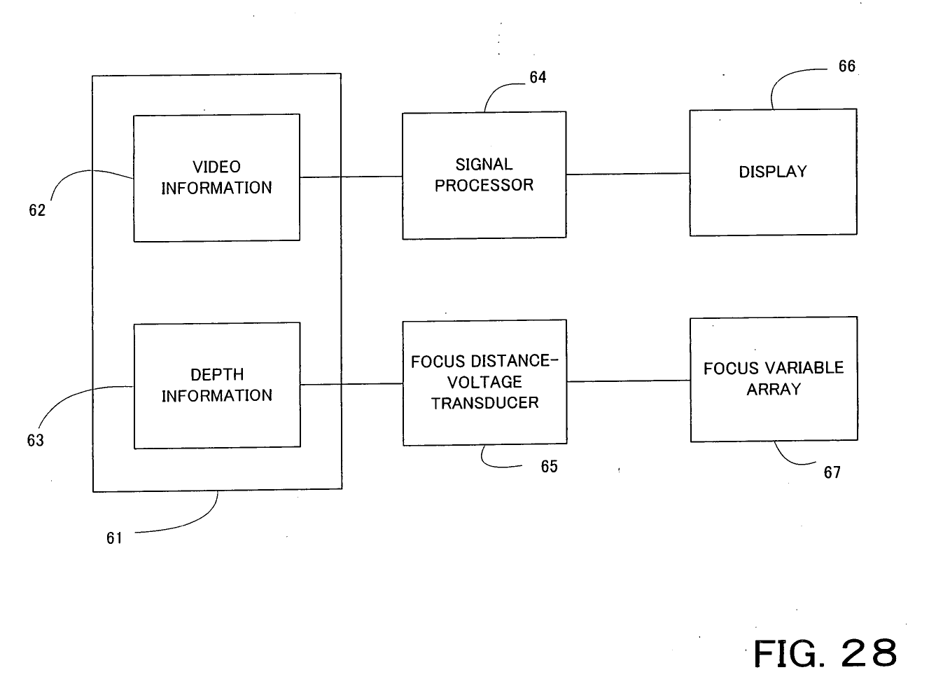

FIG. 28 shows a block diagram of the image display apparatus according to the present invention (in particular, the image display apparatus of the fourth embodiment), provided with: an image signal source 61 including video information 62 and depth information 63; a signal processor 64 for processing the video information 62; a focus distance-voltage transducer 65 for converting focus distance information to a voltage; a display 66 for displaying an image; a focus variable lens array 67 disposed forward of the display 66.

The image signal source 61 is an image signal displayed on the image display apparatus according to the present invention, including information about video, i.e. the video information 62, and information about a depth of each pixel constructing the image, i.e. the depth information 63.

The video information 62 is information about a to-be-displayed image, for which various image source may be taken including broadcasting video, reproduction video of a VCR, camera shot image/video, computer graphics and so on.

The depth information 63 is information about a depth of each pixel constructing the image, which corresponds to distance information. For each pixel, the depth information includes information corresponding to a distance of an object to be displayed. For example, depth data may be united with pixel data in the video information 62 and treated as one pixel information. When the pixel information is displayed, the depth information is separated so that the video information and the depth information have “one-on-one” relationship for displaying the image. Alternatively, an entire display plane may be treated as one block. In this case, the depth information for each portion may be generated according to a predetermined rule, for example by a calculation, or a program.

The signal processor 64 converts to an input signal form compatible to the display 66 for the display purpose.

The focus distance-voltage transducer 65 converts the focus distance of the focus variable lens to the controllable voltage, on the basis of the depth information, i.e. the distance information.

The display 66 is a device for displaying the image signal processed at the signal processor 64, and may be a CRT, an LC, an EL, a PDP and so on. Furthermore, the display plane thereof is preferably flat.

The focus variable lens array 67 is an array including focus variable lenses each corresponding to each of display pixels of the display 66. An LC lens or the like may be used as the focus variable lens array 67. A voltage converted on the basis of the depth information or the distance information at the focus distance-voltage transducer 65 is applied to the focus variable lens, so that the focus distance is controlled to focus each pixel at the focus level.

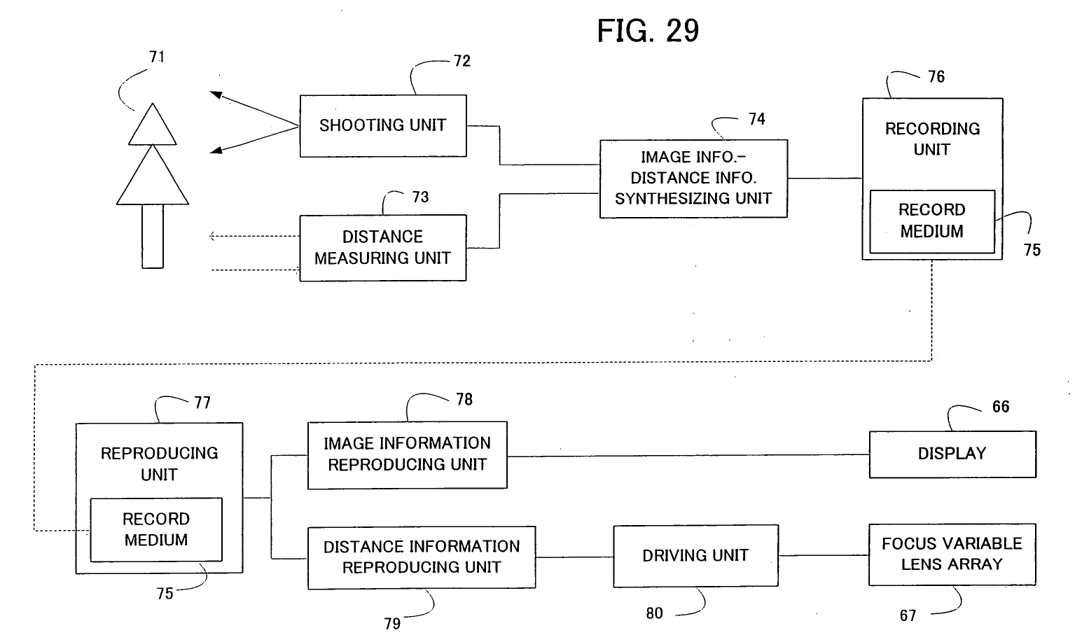

FIG. 29 illustrating the image display apparatus according to the present invention, showing an exemplary construction including a record reproduction function. There are provided with a record system including: a shooting unit 72 for shooting an object 71; a distance measuring unit 73 for measuring a distance to the object 71; an image information/distance information synthesizing unit 74 for synthesizing the shot image information and the measured distance information; and a recording unit 76 for recording the synthesized information into a record medium 75, and further provided with a reproduction system including: a reproducing unit 77 for reproducing the record medium 75; an image information reproducing unit 78 for extracting the image information to be displayed on the display 66, from the reproduced signal; a distance information reproducing unit 79 for extracting the distance information from the reproduced signal; and a driving unit 80 for driving the focus variable lens array 67 on the basis of the distance information.

In recording operation, the shooting unit 72, which may be a video camera, shoots the object 71, and thereby generates image information to be displayed as a stereoscopic image. The distance measuring unit 73 measures a distance to the object 71, at the same time as shooting. Measuring may be performed in a method using ultrasonic wave, a method using infrared radiation and so on, in which the measured distance becomes the distance information. At the image information/distance information synthesizing unit 74, the image information shot at the shooting unit 72 and the distance information measured at the distance measuring unit 73 are synthesized in association with each other. This synthesized information is recorded into the record medium 75 at the recording unit 76.

In reproducing operation, the record medium 75 in which the image information and the distance information are recorded as mentioned above is reproduced at the reproducing unit 77. With regard to the reproduction information from the record medium, the image information is extracted and separated at the image information reproducing unit 78, and the distance information is extracted and separated at the distance information reproducing unit 79. The image information extracted and separated at the image information reproducing unit 78 is displayed on the display 66. Furthermore, the distance information extracted and separated at the distance information reproducing unit 79 is inputted into the driving unit 80 to drive the focus variable lens array 67 and control the focus distance of the focus variable lens. An accurate stereoscopic image of the object 71 can be obtained, since the displayed image of a pixel of the display 66, the focus variable lens corresponding to the pixel, and the distance information of the displayed image of the pixel (i.e. the control extent of the focus variable lens) are uniquely associated.

The record medium 75 may be a magneto-optical record medium, an optical record medium, a semiconductor medium and so on. Such an intervention of the record medium 75 makes it possible to stock 3D image software and distribute it widely.

The present invention is not limited to the aforementioned embodiments, but can be modified or changed within a range without departing from the spirit or essence of the present invention read from the whole specification and the claims. The image display apparatus and method involving such a modification or change are also encompassed within a scope of the invention.

### INDUSTRIAL APPLICABILITY

The image display apparatus and the image display method according to the present invention may be applicable to an image display apparatus and an image display method allowing the image display including a 3D image display used in various fields such as entertainment, design, medical and so on.

1. (canceled)

2. An image display apparatus comprising:
a two dimensional image displaying device for displaying a two dimensional image;
an image providing device including a plurality of lenses disposed in front of and parallel to a display plane of said two dimensional displaying device, each lens having any static one of a plurality of different focus distances; and
an image signal generating device for generating an image signal of the two dimensional image, corresponding to the focus distance of each lens, on the basis of distance information which indicates the image provided position of each of a plurality of image portions consisting the two dimensional image.

3. The image display apparatus according to claim 2, wherein
said image providing device is configured by a plurality of stocked lens arrays.

4. The image display apparatus according to claim 2, wherein
said image providing device is set to provide an image of said two dimensional image displaying device at fronts of a display plane of said two dimensional image displaying device.

5. The image display apparatus according to claim 2, wherein
said image providing device is set to provide an image of said two dimensional image displaying device at rears of a display plane of said two dimensional image displaying device.

6. The image displaying apparatus according to claim 2, wherein
the lens is an aspheric lens.

7. The image displaying apparatus according to claim 2, wherein
the lens is a Fresnel lens.

8. The image displaying apparatus according to claim 2, wherein
the lens is a grated index lens.

9. The image displaying apparatus according to claim 2, wherein
a member having a predetermined refractive index is inserted between the lens and said two dimensional image displaying device.

10. The image displaying apparatus according to claim 2, wherein
a separating device for optically separating the plurality of lenses is disposed between the plurality of lenses and said two dimensional image displaying device.

11. The image displaying device according to claim 2, wherein
said two dimensional image displaying device is a cathode ray tube displaying device.

12. The image displaying device according to claim 2, wherein
said two dimensional image displaying device is a liquid crystal displaying device.

13. The image displaying device according to claim 2, wherein
said two dimensional image displaying device is an electroluminescence displaying device.

14. The image displaying device according to claim 2, wherein
said two dimensional image displaying device is a plasma displaying device.

15. The image displaying device according to claim 2, wherein
the plurality of lenses are disposed corresponding to each of pixels of said two dimensional image displaying device.

16. The image displaying apparatus according to claim 2, wherein
the plurality of lenses are disposed corresponding to a predetermined block of pixels of said two dimensional image displaying device.

17. The image displaying apparatus according to claim 2, wherein
the plurality of lenses are disposed along a horizontal line of said two dimensional image displaying device.

18. The image displaying apparatus according to claim 2, wherein
the plurality of lenses are disposed along a vertical line of said two dimensional image displaying device.

19. The image displaying apparatus according to claim 2, wherein
the image signal generating device includes at least one of brightness information, color information, size information and focus information, which are added to an image displayed on the display plane.

20. The image displaying apparatus comprising:
a two dimensional image displaying device for displaying a two dimensional image;
an image providing device made of a plurality of focus variable lenses disposed in front of and parallel to a display plane of said two dimensional image displaying device;
an image signal generating device for generating an image signal of the two dimensional image and information about a focus distance of the focus variable lens, on the basis of distance information which indicates the image provided position of each of a plurality of image portions consisting the two dimensional image; and
a focus distance controlling device for controlling the focus distance of the focus variable lens, on the basis of the information about focus distance,
said image providing device providing the two dimensional image as an upright image.

21. The image displaying apparatus according to claim 20, wherein
the plurality of the focus variable lenses are disposed corresponding to each of pixels of said two dimensional image displaying device.

22. The image displaying apparatus according to claim 20, wherein
the plurality of the focus variable lenses are disposed corresponding to a predetermined block of pixels of said two dimensional image displaying device.

23. The image displaying apparatus according to claim 20, wherein
the focus variable lens is a liquid crystal lens.

24. The image displaying apparatus according to claim 23, wherein
the liquid crystal lens is a lens system including a fix lens.

25. The image displaying apparatus according to claim 24, wherein
the fix lens is disposed at a liquid crystal side of the liquid crystal lens, or an opposite side to the liquid crystal side, or at said both side.

26. The image displaying apparatus according to claim 24, wherein
the fix lens is an aspheric lens.

27. The image displaying apparatus according to claim 24, wherein
the fix lens is a Fresnel lens.

28. The image displaying apparatus according to claim 24, wherein
the fix lens is a grated index lens.

29. The image displaying apparatus according to claim 20, wherein
a member having a predetermined refractive index is inserted between the focus variable lens and said two dimensional image displaying device.

30. The image displaying apparatus according to claim 20, wherein
a separating device for optically separating the plurality of focus variable lenses is disposed between the plurality of focus variable lenses and said two dimensional image displaying device.

31. The image displaying apparatus according to claim 20, wherein
said two dimensional image displaying device is a cathode ray tube displaying device.

32. The image displaying apparatus according to claim 20, wherein
said two dimensional image displaying device is a liquid crystal displaying device.

33. The image displaying apparatus according to claim 20, wherein
said two dimensional image displaying device is an electroluminescence displaying device.

34. The image displaying apparatus according to claim 20, wherein
said two dimensional image displaying device is a plasma displaying device.

35. The image displaying apparatus according to claim 20, wherein
the image signal generating device includes at least one of brightness information, color information, size information and focus information, which are added to an image displayed on the display plane.

36. (canceled)

37. An image displaying method comprising:
disposing an image providing device made of a plurality of lenses, each lens having any static one of focus distances, disposed in front of and parallel to a display plane of a two dimensional image displaying device for displaying a two dimensional image, displaying the two dimensional image by inputting an image signal, which is generated by an image signal generating device corresponding to each focus distance of the lenses on the basis of distance information which indicates the image provided position of each of a plurality of image portions consisting the two dimensional image, into the two dimensional image displaying device, and providing the displayed two dimensional image by the image providing device at a position different from the display plane.

38. An image displaying method comprising:
disposing an image providing device made of a plurality of focus variable lenses disposed in front of and parallel to a display plane of a two dimensional image displaying device for displaying a two dimensional image, displaying an image by inputting an image signal, which is generated by an image signal generating device on the basis of distance information which indicates the image provided position of each of a plurality of image portions consisting the two dimensional image, into the two dimensional image displaying device, and providing the to-be-displayed two dimensional image as an upright image at any position by controlling a focus distance of the focus variable lens on the basis of the distance information.
